(19) United States
(12) Patent Application Publication
(10) Pub. No.: US 2016/0026382 A1
(43) Pub. Date: Jan. 28, 2016

(54) Touch-Based Flow Keyboard For Small Displays

(71) Applicant: QUALCOMM Incorporated, San Diego, CA (US)

(72) Inventors: Daniel Rivas, San Diego, CA (US); Steven Michael Smith, San Diego, CA (US)

(21) Appl. No.: 14/701,364

(22) Filed: Apr. 30, 2015

Related U.S. Application Data
(60) Provisional application No. 62/027,421, filed on Jul. 22, 2014.

(51) Int. Cl. G06F 3/0488; G06F 3/023; G06F 3/041

(52) U.S. Cl. CPC G06F 3/04886; G06F 3/0416; G06F 3/0233

(57) ABSTRACT

Systems, methods, and devices of the various embodiments enable a full keyboard of characters, such as Latin-based characters, to fit on a small touchscreen display. In an embodiment, a keyboard may be displayed including a text entry area and six virtual buttons. As a user interacts with the displayed keyboard, event actions may be determined based on the current displayed keyboard, the user input action indications received, and the text entry area state. The determined event actions may include displaying further keyboards, generating characters, and/or outputting character strings, and the event actions may be executed to enable the user to control character entry on a touchscreen display.

### CROSS REFERENCE TO RELATED APPLICATIONS

This application claims the benefit of priority to U.S. Provisional Patent Application No. 62/027,421 entitled “Touch-Based Flow Keyboard For Small Displays” filed Jul. 22, 2014, the entire contents of which are hereby incorporated by reference.

### BACKGROUND

On current small displays, such as the displays typically associated with smart watches or other wearable computing devices, text input is difficult due to the small touchscreen size. In these current small display computing devices, creating text messages has been limited to selecting pre-written messages or using touchscreen simulated dials to select a single letter at a time, because touch keyboards could not be fit in the small display area.

### SUMMARY

The systems, methods, and devices of the various embodiments enable a full keyboard of characters, such as Latin-based characters, to be implemented on a computing device with a small display and user interface, such as a wearable computing device. In an embodiment, a keyboard may be displayed on a touch-sensitive display screen (“touchscreen”) in which the keyboard includes a text entry area and a set of virtual buttons that may range from four to eight (e.g., six virtual buttons), depending on the touchscreen size and button sizes. As a user interacts with the displayed keyboard by touching the touchscreen in various parts, event actions may be determined based on the currently displayed keyboard, the user input action indications received, and the text entry area state. The determined event actions may include displaying further keyboards, generating characters, and/or outputting character strings. The determined event actions may then be executed by the computing device to enable the user to control character entry on a small touchscreen.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a component diagram of an example computing device suitable for use with the various embodiments.

FIG. 1B is a process flow diagram illustrating an embodiment method for displaying a full keyboard of characters, such as Latin-based characters, that fit on a small touchscreen.

FIGS. 2A-13 illustrate examples of keyboards and interaction tables providing a full keyboard of characters, such as Latin-based characters, that fit on a small touchscreen according to an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used herein to refer to any one or all of smart watches, wearable computers (e.g., computing devices in the form of a badge, tag, bracelet, patch, belt buckle, medallion, pen, key chain, or any other device worn or carried by a user), cellular telephones, smart phones, personal or mobile multi-media players, personal data assistants (PDA's), wireless electronic mail receivers, multimedia Internet enabled cellular telephones, wireless gaming controllers, and similar personal electronic devices that include one or more programmable processor, memory, and a touchscreen display or similar user interface for displaying characters.

The systems, methods, and devices of the various embodiments enable a full keyboard of characters, such as Latin-based characters, to be presented on a small screen of a computing device, particularly a touchscreen display with a size that only enables four to eight virtual buttons to be displayed. In an embodiment, the keyboard displayed on the touchscreen of the computing device may be sectioned into a text section that is actionable and a specific action button section that may be selectable for purposes of confirming or dismissing the keyboard. In an embodiment, the keyboard may have a series of virtual buttons on which characters, such as letters and numbers, may be displayed. For example, the keyboard may have six virtual buttons. In an embodiment, tapping any one of the virtual buttons may bring up the individual virtual buttons for selection. In an embodiment, the user may also swipe the touchscreen to display additional keyboards, such as additional keyboards to access lower case letters and/or special characters. As an example, the user may swipe left and right to toggle between keyboards. In an embodiment, long pressing specific individual characters may allow selecting alternate versions of the selected characters, such as alternate versions with accent marks or other adornments. The various embodiments may provide users with improved interaction with small touchscreen display devices by offering the users a full keyboard of characters with which to type, which may represent an improvement over conventional interactions with small touchscreen display devices that have relied on pre-selected text selections or voice inputs.

As a user interacts with the displayed keyboard, event actions may be determined based on the current displayed keyboard, the user input action indications received, and the text entry area state. The determined event actions may include displaying further keyboards, generating characters, and/or outputting character strings. The determined event actions may be executed to enable the user to control character entry on a small touchscreen.

User input action indications may be indications of a user tapping (i.e., a tap) on the touchscreen (e.g., by putting a finger down on the touchscreen and lifting it back off the touchscreen within a period of time), a user tapping and holding (i.e., a tap and hold) on the touchscreen for a period of time (e.g., by putting a finger down on the touchscreen and leaving the finger depressed on the touchscreen), a user tapping twice (i.e., a double tap) within a period of time (e.g., by repeating a tap in the same portion of the touchscreen in quick succession), a user swiping (i.e., a swipe) the touchscreen (e.g., by dragging a finger across a portion of the touchscreen), or any other user input to the touchscreen. As an example, a user's interaction with the displayed keyboard may be registered as a tap, and a tap user input action may be generated when a user's finger (e.g., a finger down event) is detected on the touchscreen and remains in the same fifteen pixel radius for 100 milliseconds. As another example, a user's interaction with the displayed keyboard may be registered as a tap and hold, and a tap and hold user input action may be generated when a user's finger is detected (e.g., a finger down event) on the touchscreen and remains in the same fifteen pixel radius for 150 milliseconds. As a further example, a user's interaction with the displayed keyboard may be registered as a double tap, and a double tap user input action may be generated when a user's finger (e.g., a finger down event) is detected on the touchscreen for a second time within 500 milliseconds of a first tap in the same thirty pixel by thirty pixel area as the first tap. As a further example, a user's interaction with the displayed keyboard may be registered as a swipe, and a swipe user input action may be generated when a user's finger (e.g., a finger down event) is detected on the touchscreen and remains on the touchscreen longer than 150 milliseconds and moves at least fifteen pixels across a portion of the touchscreen.

In an embodiment, a tap on the displayed keyboard may cause the displayed keyboard to transition to a subsequent (or second) displayed keyboard with an expanded set of displayed buttons (or keys), and the user may tap the other displayed buttons (or keys) to further interact with the keyboard, such as to select a displayed character. In another embodiment, a tap and hold on the displayed keyboard may cause the displayed keyboard to transition to a subsequent (or second) displayed keyboard with an expanded set of displayed buttons (or keys), and the user may drag his or her finger to the other displayed buttons (or keys) to further interact with the keyboard, such as to select a displayed character. In this manner, the ability to tap and drag to select a displayed character of the expanded set of displayed buttons (or keys) may improve a users typing speed when compared with keyboards that require multiple tap events to select buttons (or keys).

In an embodiment, a user may interact with the text entry area of a displayed keyboard to cause an event action to occur. A tap in the text entry area may add a space to the end of character string displayed in the text entry area. A tap and hold in the text entry area may cause a cursor control keyboard to be displayed. The character string may be enlarged in the cursor control keyboard and the user may tap at a portion of the character string to move the cursor position within the character string. The user may also clear the characters in the character string or undo a clear of characters.

In an embodiment, the subsequent (or second) displayed keyboard with an expanded set of displayed buttons may display the expanded set of displayed buttons such that the buttons expand out to portions of the touchscreen away from where the user's finger was depressed on the touchscreen. In an embodiment, the keyboards may not be “QWERTY” style keyboards. In the various embodiments, the second displayed keyboard with an expanded set of displayed buttons may be displayed overtop the original displayed keyboard such that a portion or the entire original displayed keyboard remains visible to the user. In this manner, the second displayed keyboard with an expanded set of displayed buttons may represent a magnified section of the original displayed keyboard.

In an embodiment, event actions may be determined based on the current displayed keyboard, the user input action indications received, and the text entry area state by using a look up function to select an event action listed in an interaction table associated with each displayed keyboard correlating user input action indications and text entry area states with event actions. In another embodiment, event actions may be determined by a series of logic statements testing the current displayed keyboard, the user input action indications received, and the text entry area state and outputting event actions based on the test results.

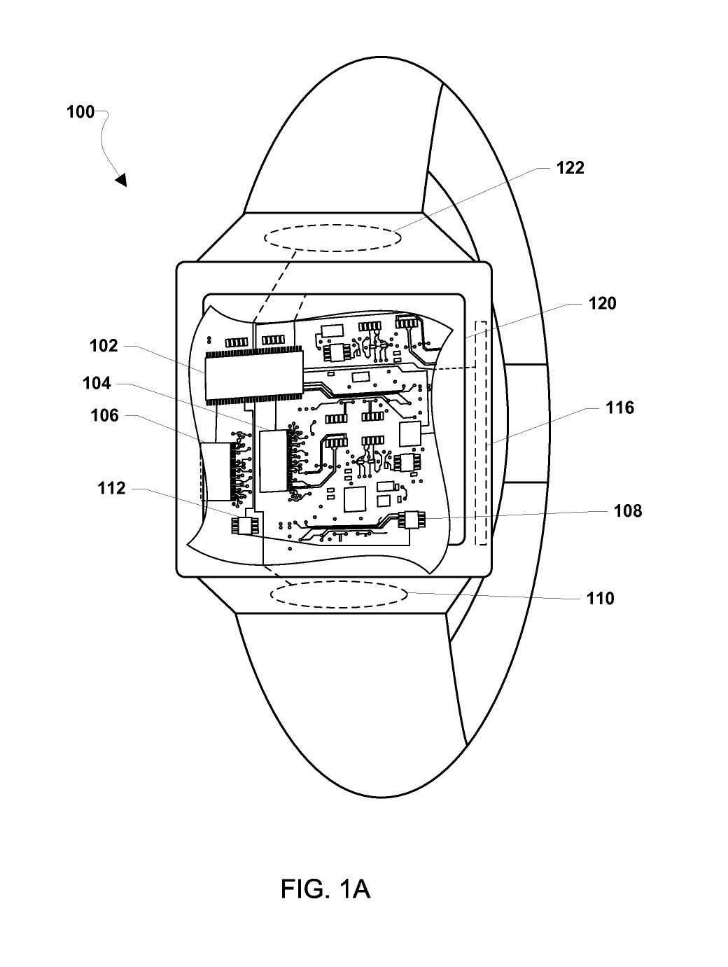

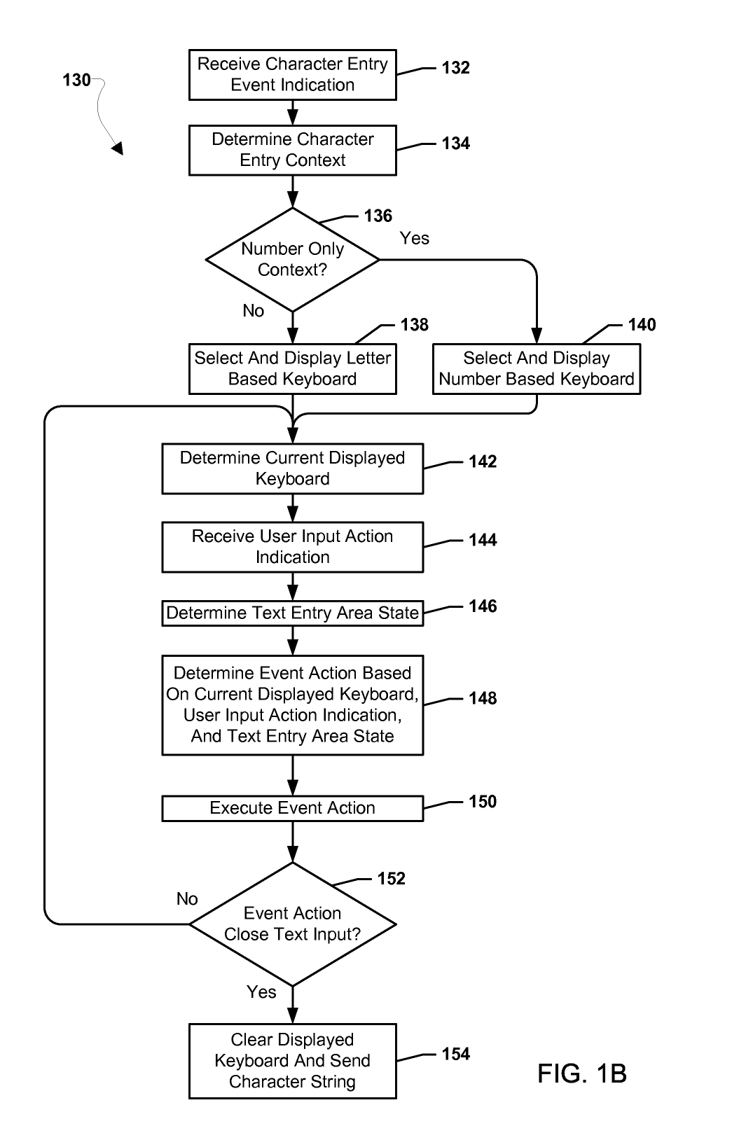

The various embodiments may be implemented within a variety of computing devices, such as a wearable computing device. FIG. 1A illustrates an example wearable computing device in the form of a smart watch 100. A smart watch 100 may include a processor 102 coupled to internal memories 104 and 106. Internal memories 104, 106 may be volatile or non-volatile memories, and may also be secure and/or encrypted memories, or unsecure and/or unencrypted memories, or any combination thereof. The processor 102 may also be coupled to a touchscreen display 120, such as a resistive-sensing touchscreen, capacitive-sensing touchscreen infrared sensing touchscreen, or the like. Additionally, the smart watch 100 may have one or more antenna 108 for sending and receiving electromagnetic radiation that may be connected to one or more wireless data links 112, such as one or more Bluetooth® transceivers, Peanut transceivers, Wi-Fi transceivers, ANT+ transceivers, etc., which may be coupled to the processor 102. The smart watch 100 may also include physical virtual buttons 122 and 110 for receiving user inputs as well as a slide sensor 116 for receiving user inputs.

The touchscreen display 120 may be coupled to a touchscreen interface module 106 that is configured receive signals from the touchscreen display 120 indicative of locations on the screen where a user's finger tip or a stylus is touching the surface and output to the processor 102 information regarding the coordinates of touch events. Further, the processor 102 may be configured with processor-executable instructions to correlate images presented on the touchscreen display 120 with the location of touch events received from the touchscreen interface module 106 in order to detect when a user has interacted with a graphical interface icon, such as a virtual button.

The processor 102 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the processor 102. The processor 102 may include internal memory sufficient to store the application software instructions. In many devices the internal memory may be a volatile or nonvolatile memory, such as flash memory, or a mixture of both. For the purposes of this description, a general reference to memory refers to memory accessible by the processor 102 including internal memory or removable memory plugged into the mobile device and memory within the processor 102 itself

FIG. 1B illustrates an embodiment method 130 for displaying a full keyboard of characters, such as Latin-based characters, that fit on a small touchscreen, such as touchscreen display 120. In an embodiment, the operations of method 130 may be performed by a processor of a computing device, such as a smart watch 100. In block 132, the processor may receive a character entry event indication. As an example, a character entry event indication may be an API call to display a keyboard made by another program running on the processor when a character string, such as a string of ASCII characters, is needed by that other program. In block 134 the processor may determine the character entry context. As an example, the processor may determine whether letters, number, and/or other characters (e.g., a sentence of text including punctuation), only letters (e.g., a name), or only numbers (e.g., a phone number) should be entered for the character string.

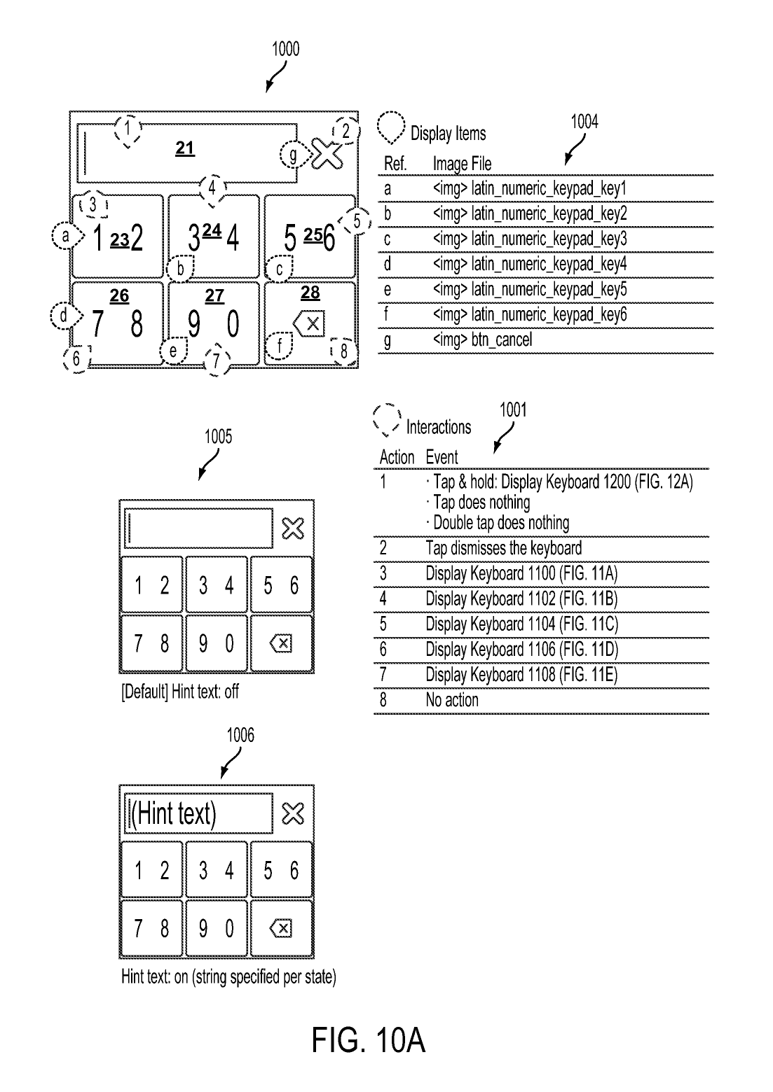

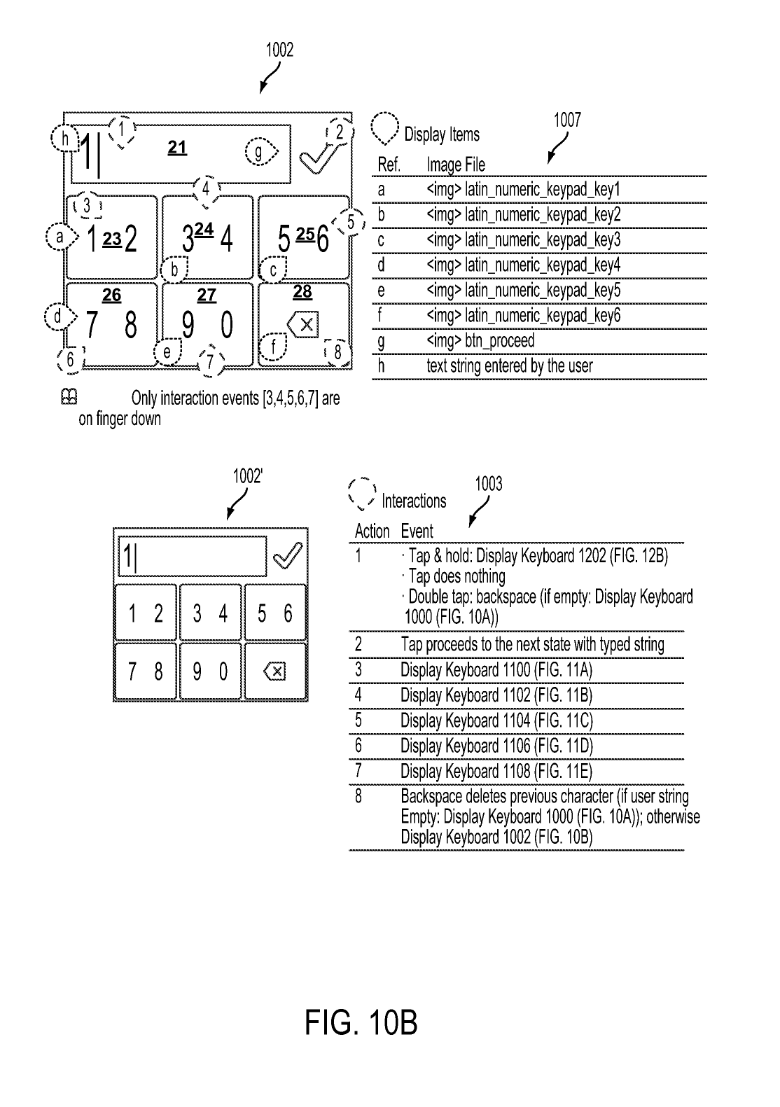

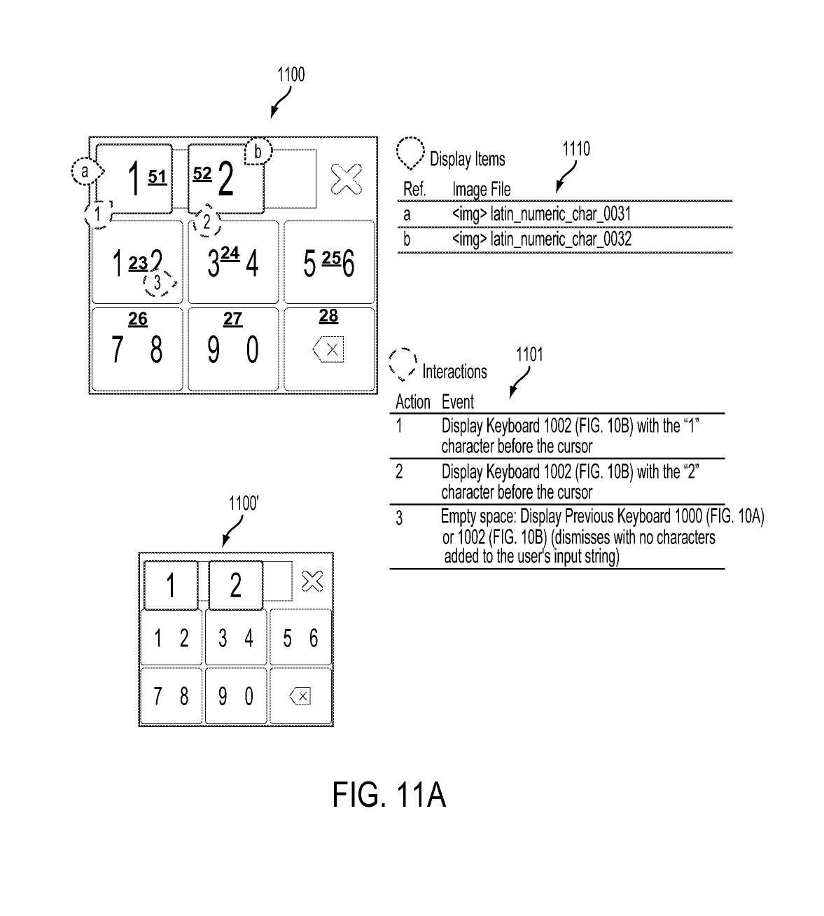

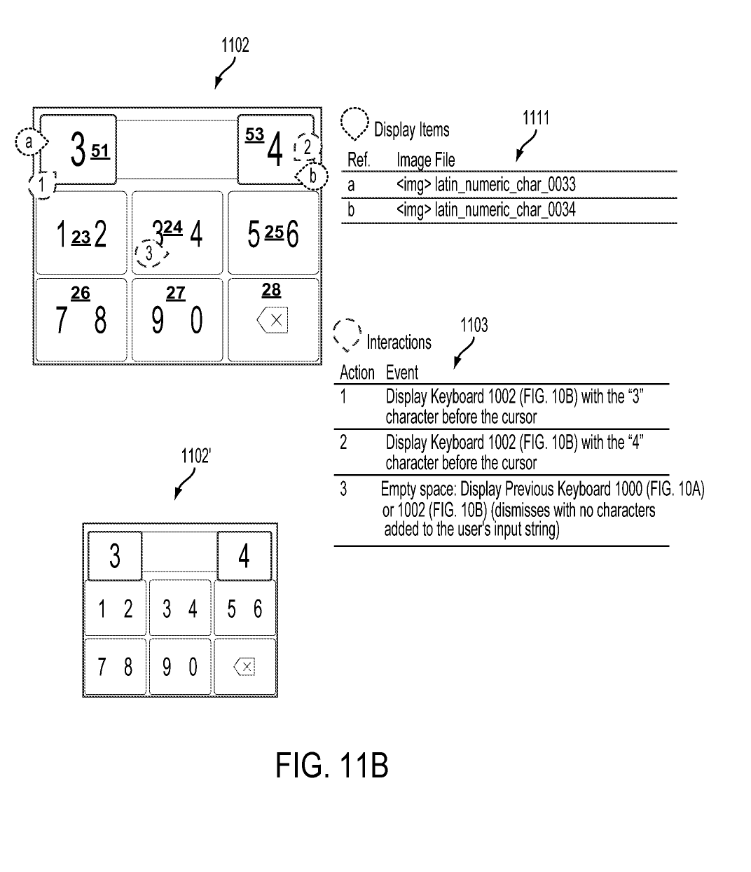

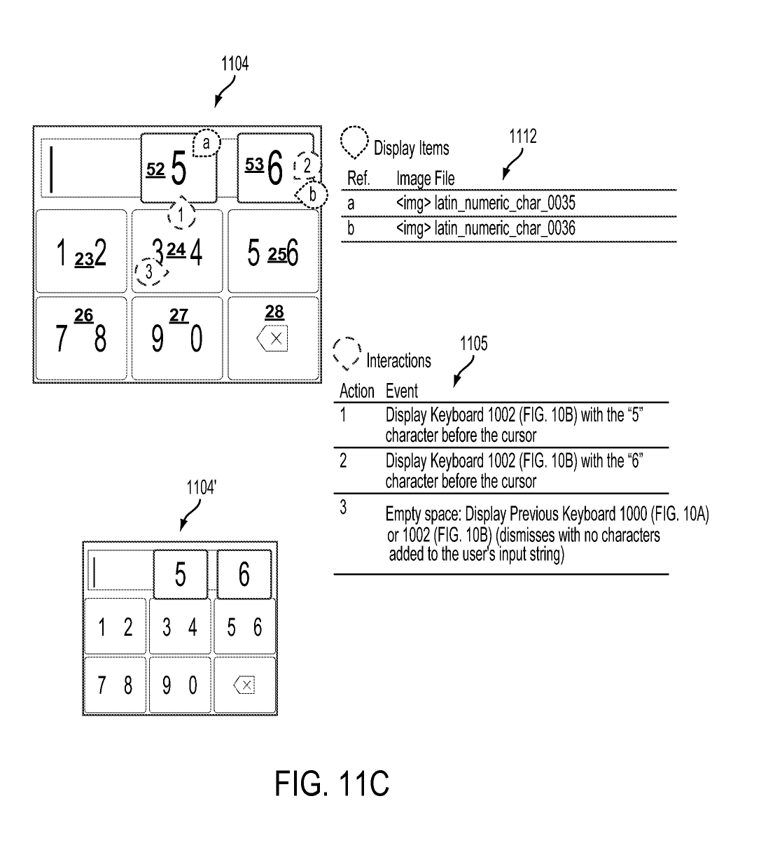

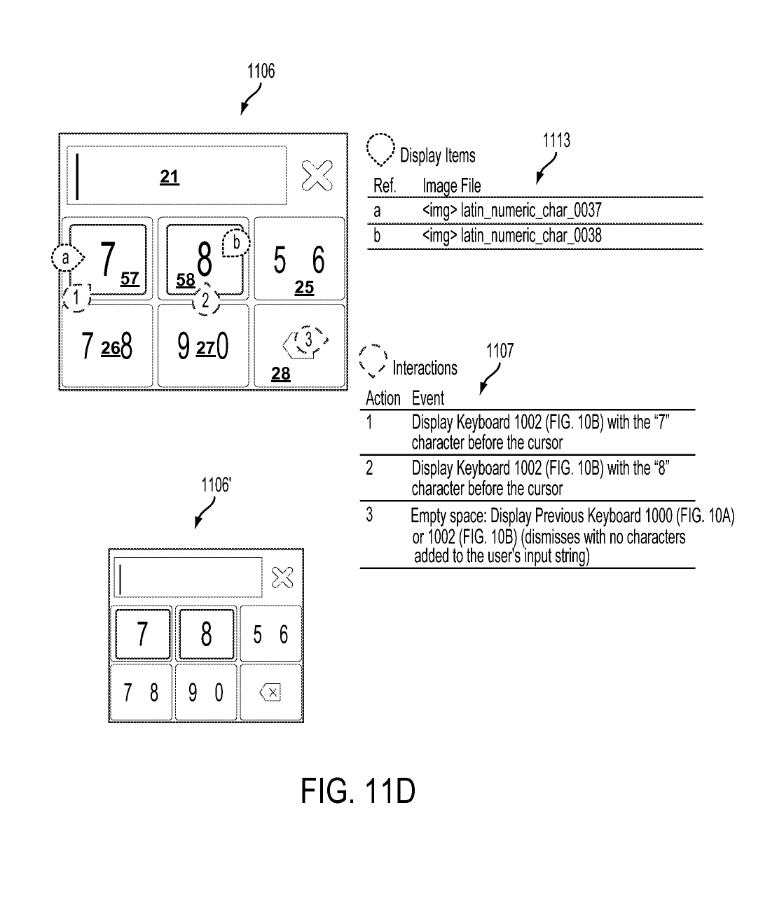

In determination block 136 the processor may determine whether the current character context is to numbers only. In response to determining the context is number only (i.e., determination block 136=“Yes”), the processor may select and display the number based keyboard in block 140. For example, the processor may generate keyboards 1000 (FIG. 10A) or 1002 (FIG. 10B) described below.

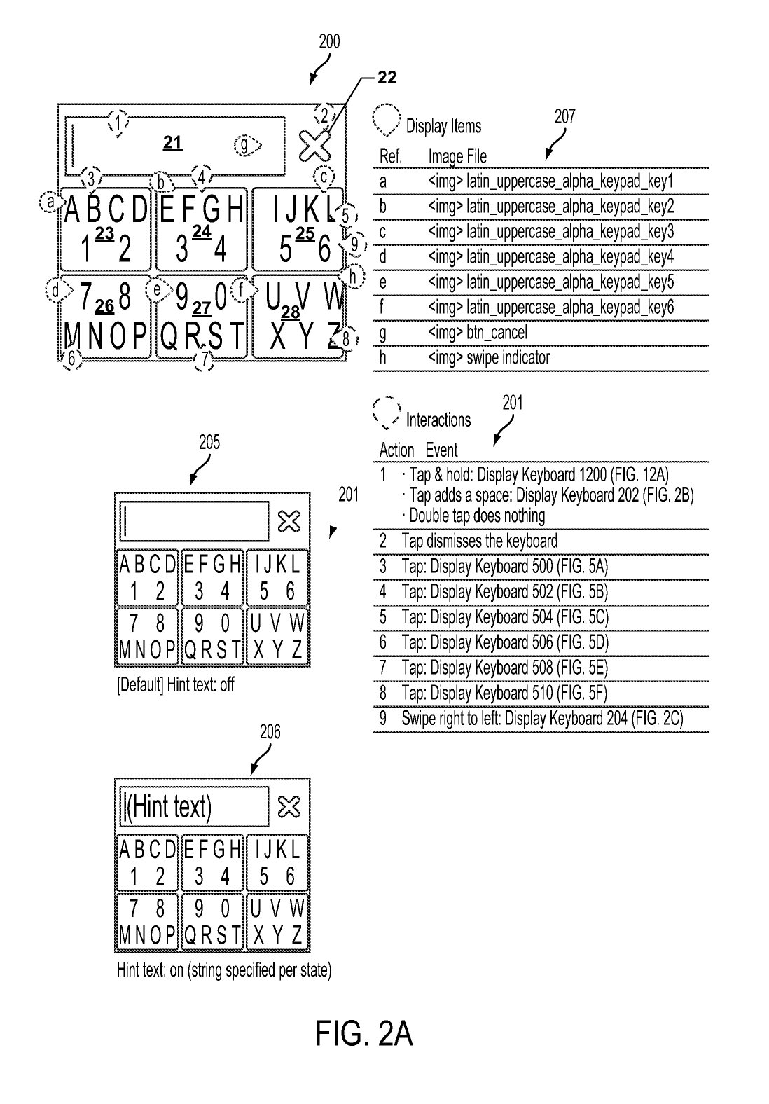

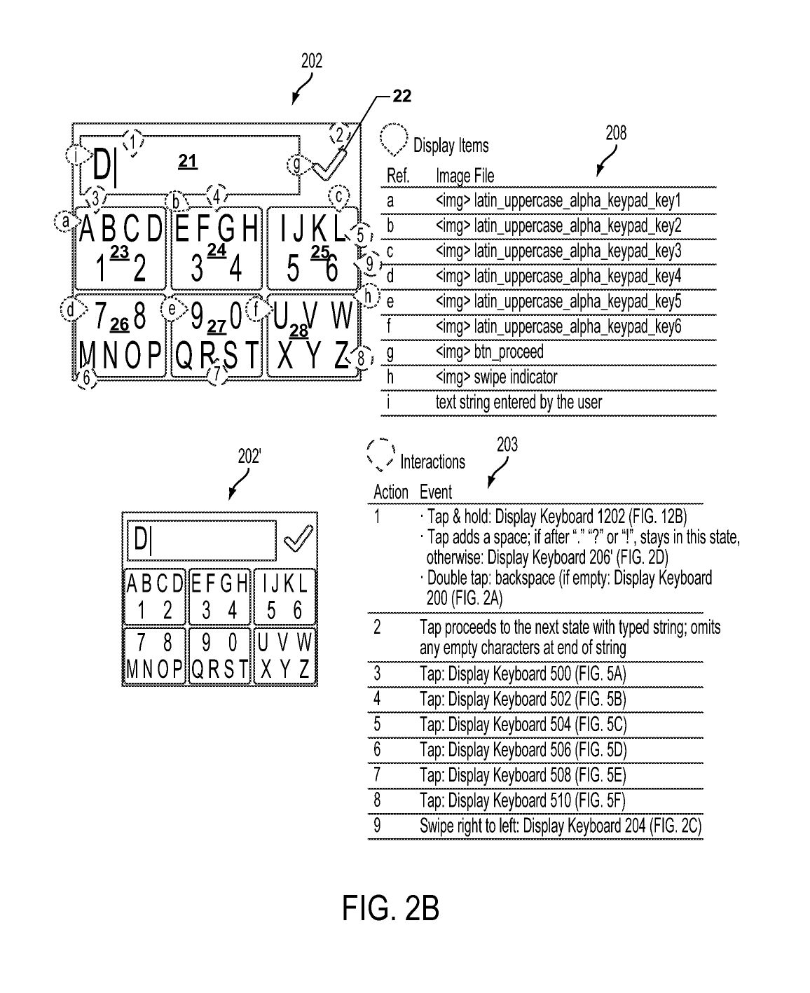

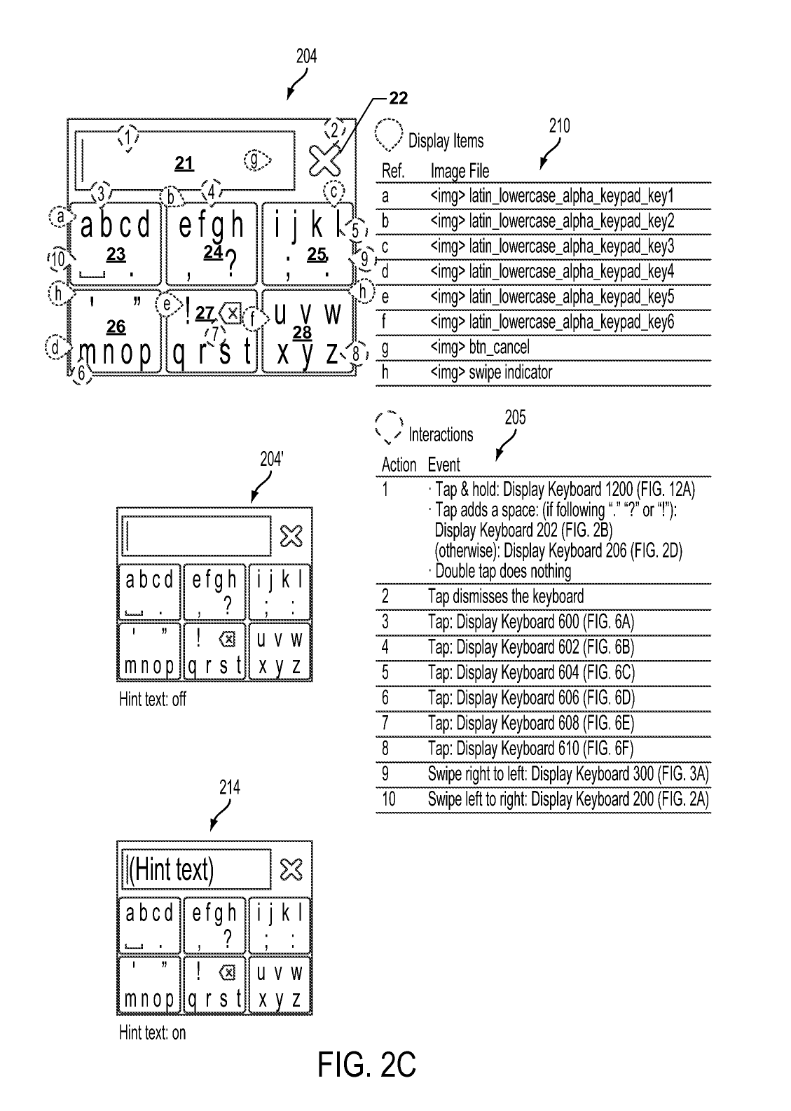

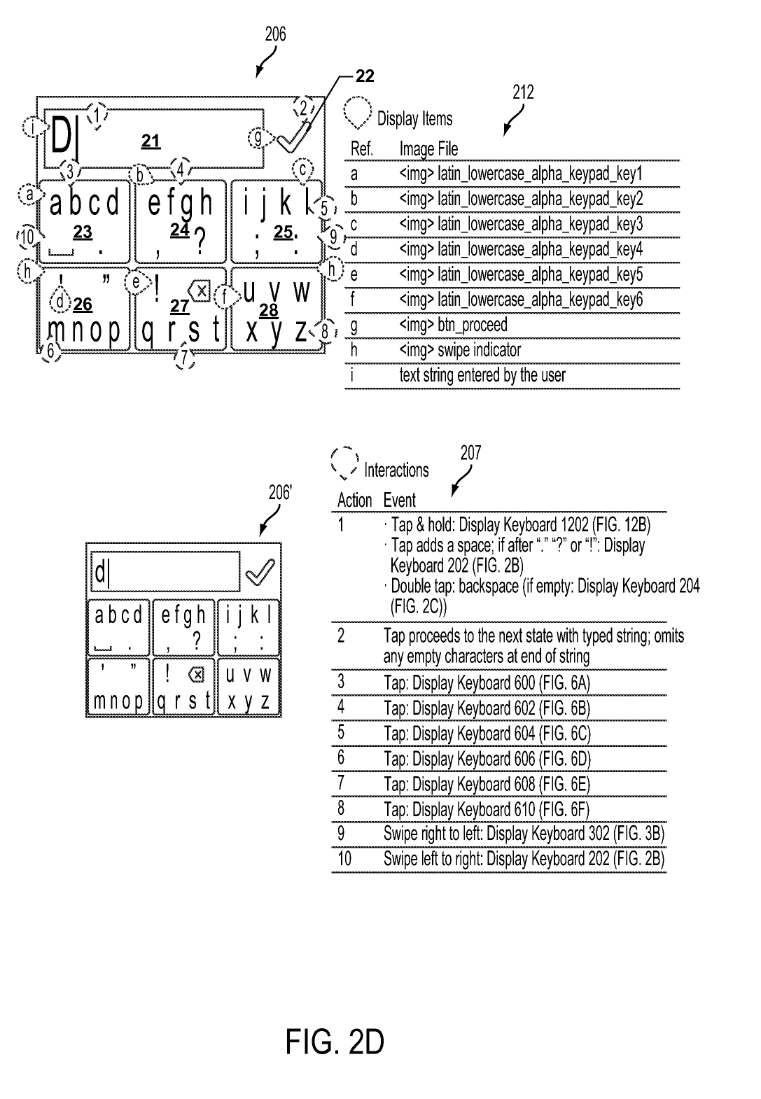

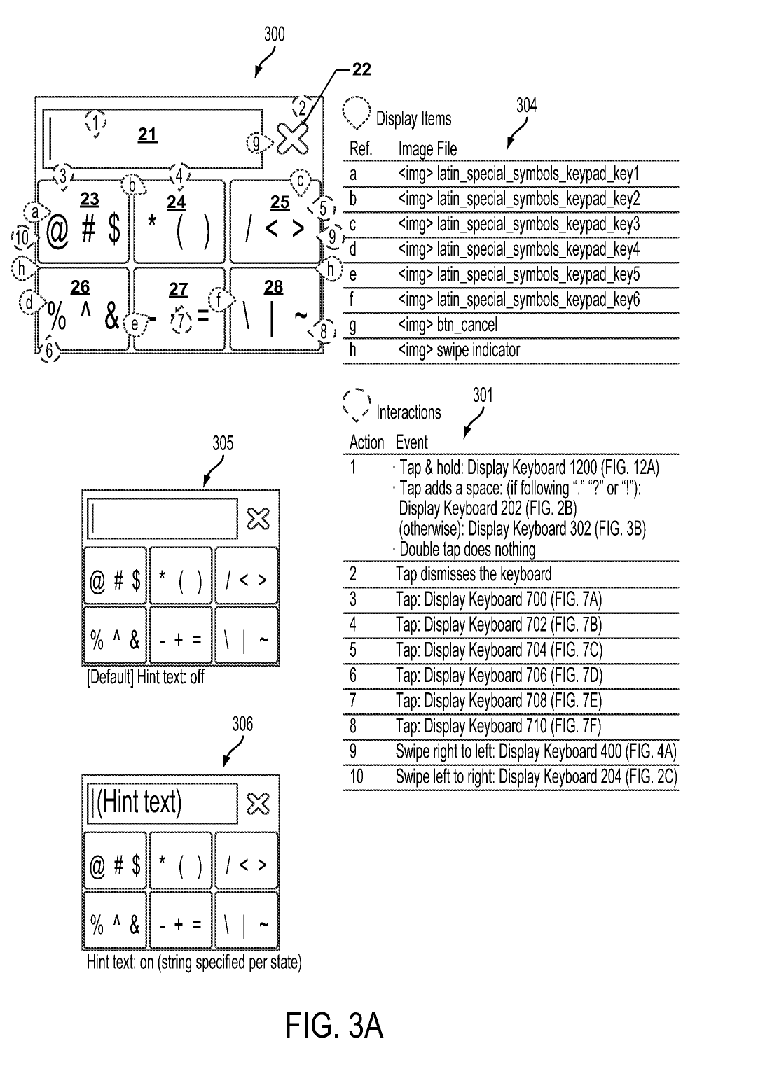

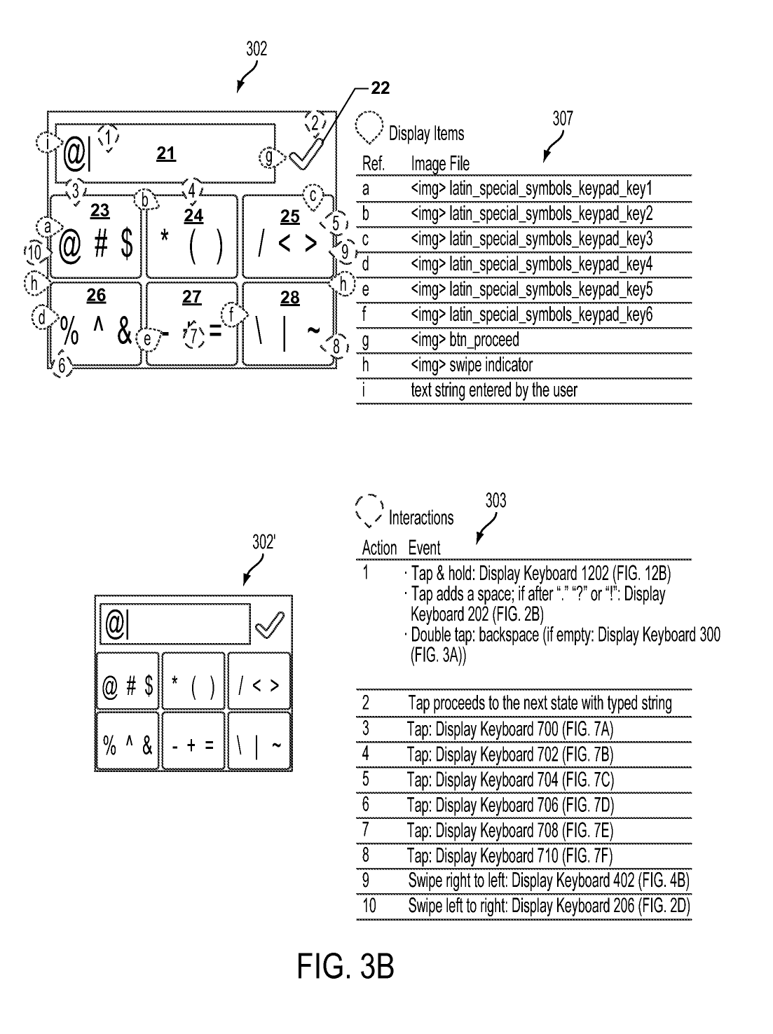

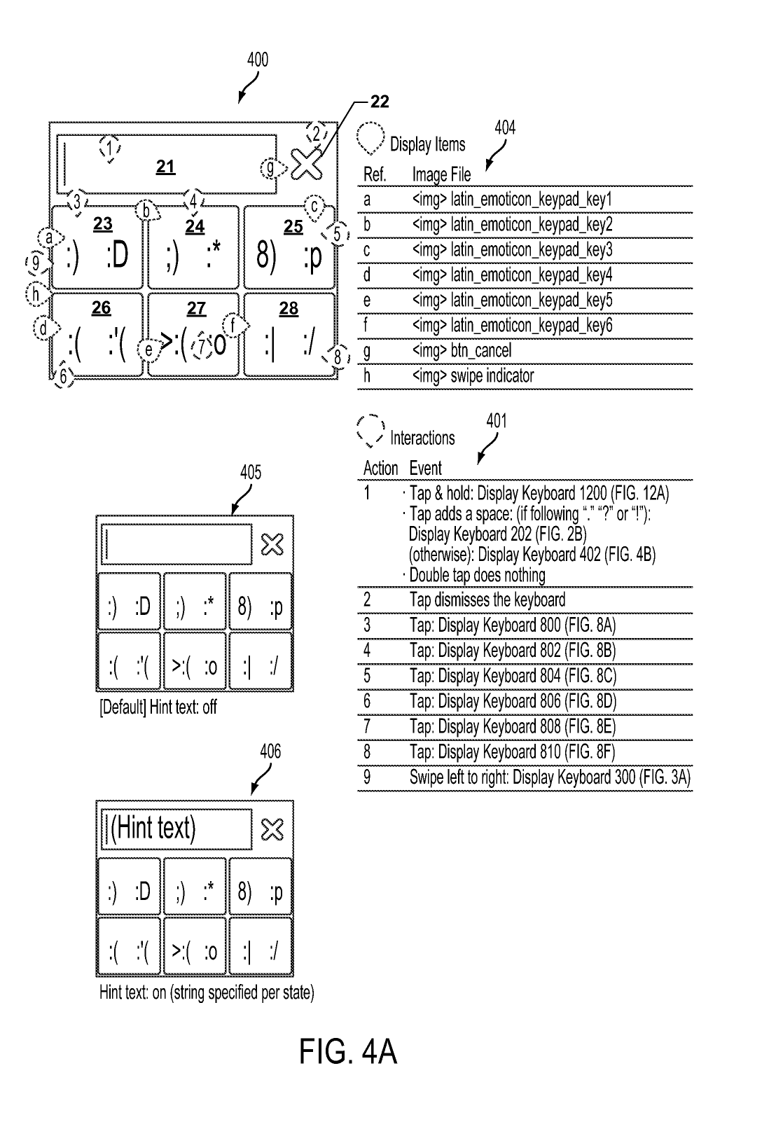

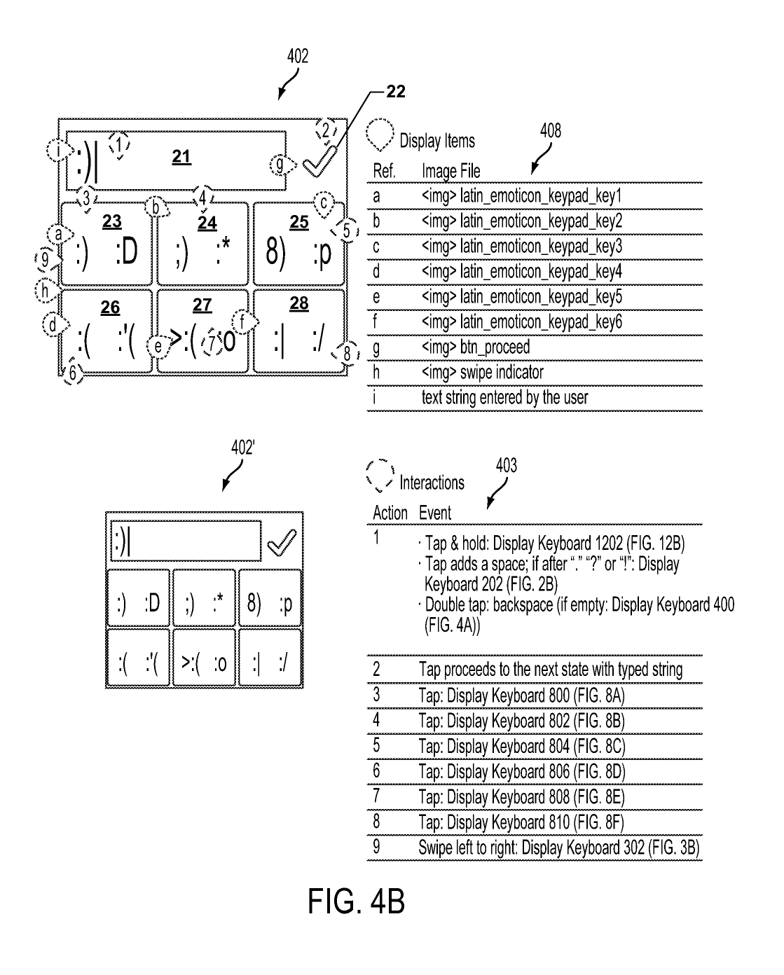

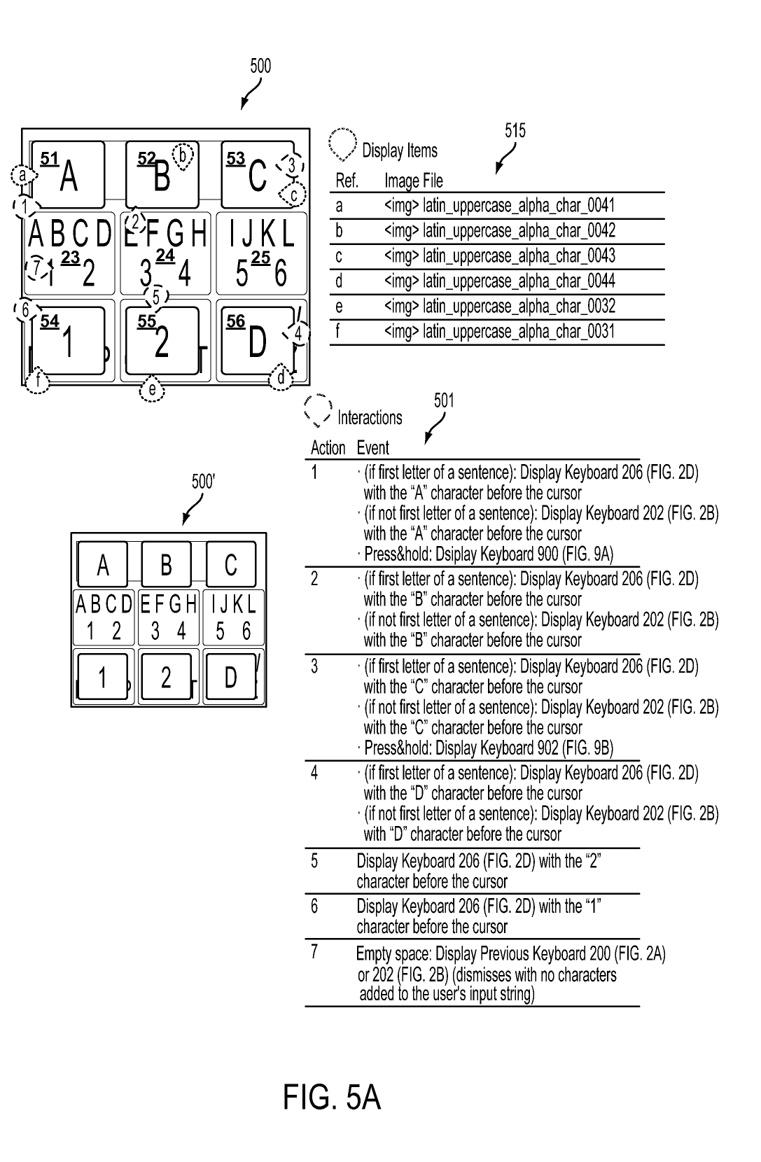

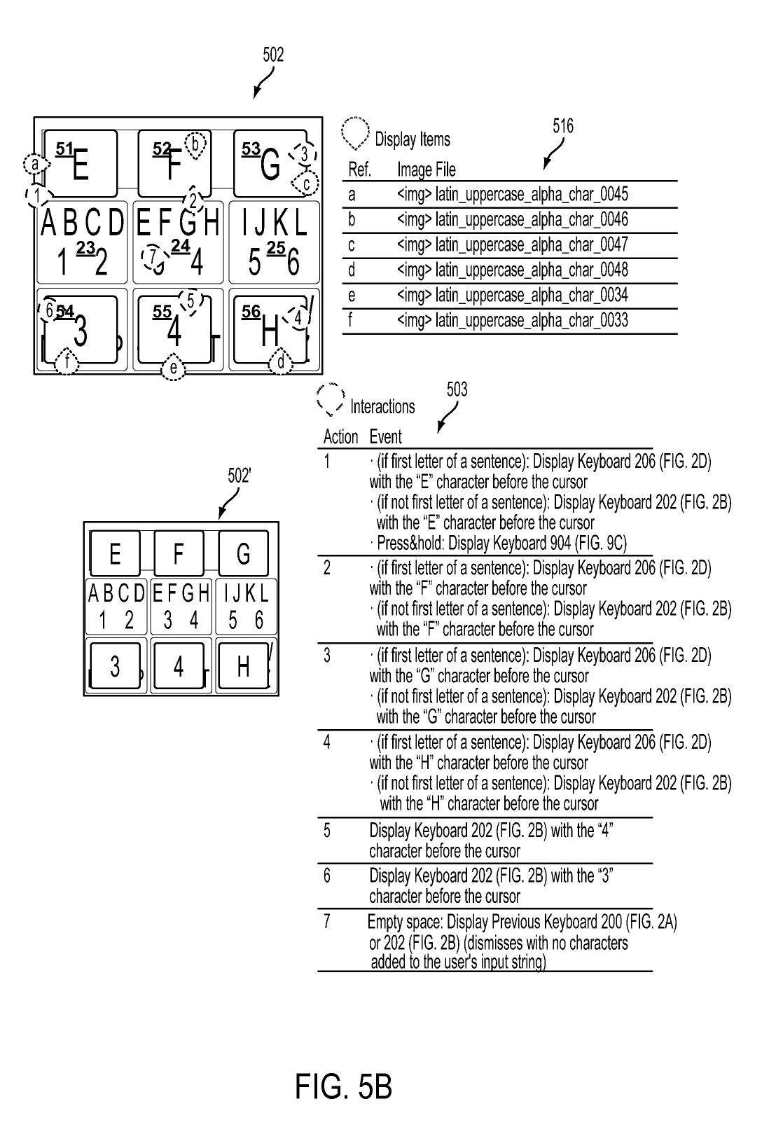

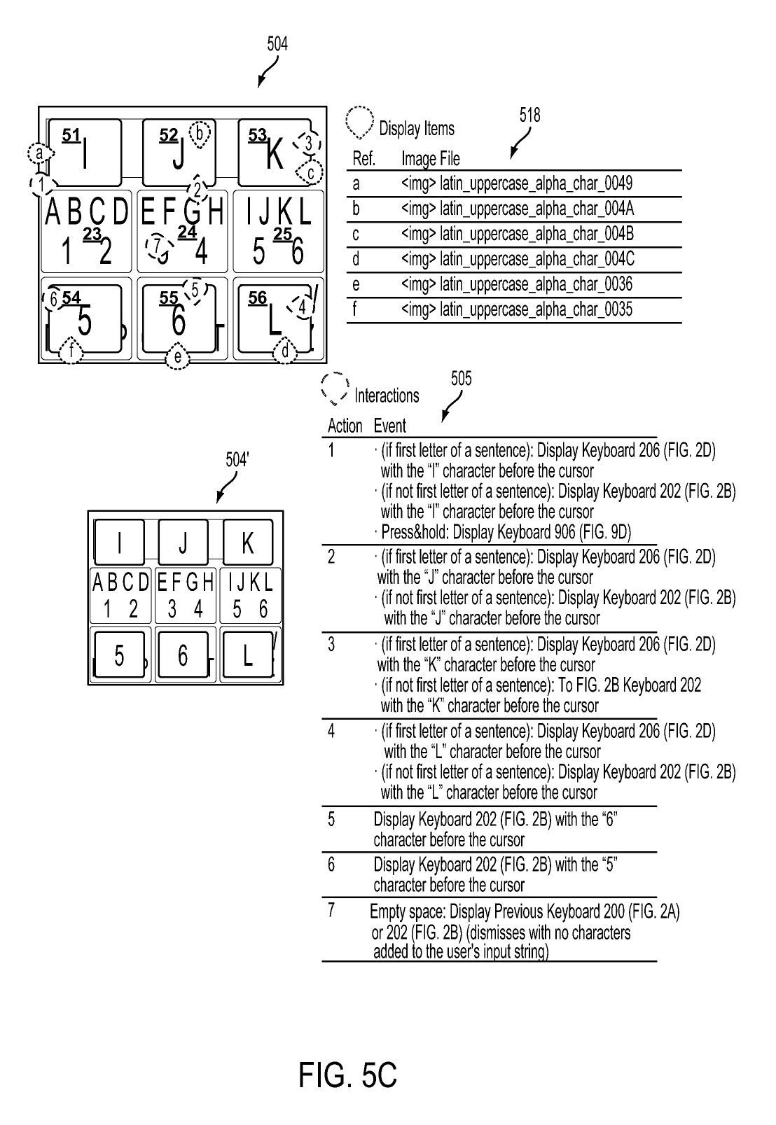

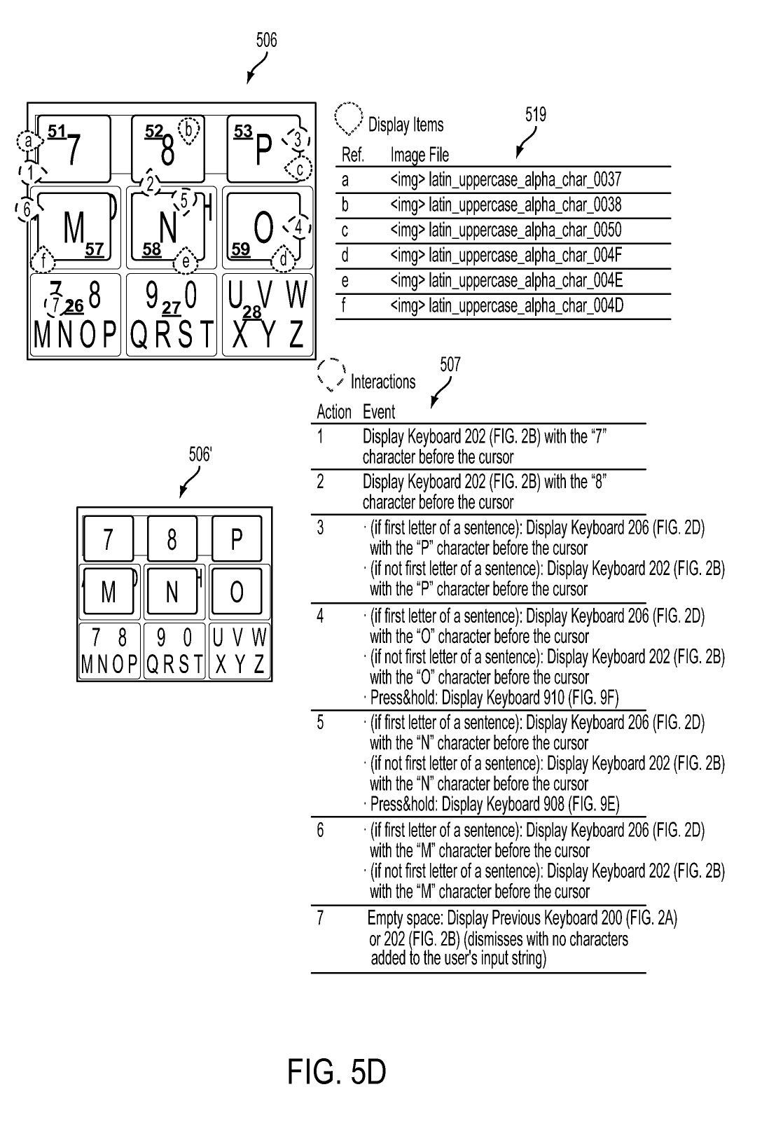

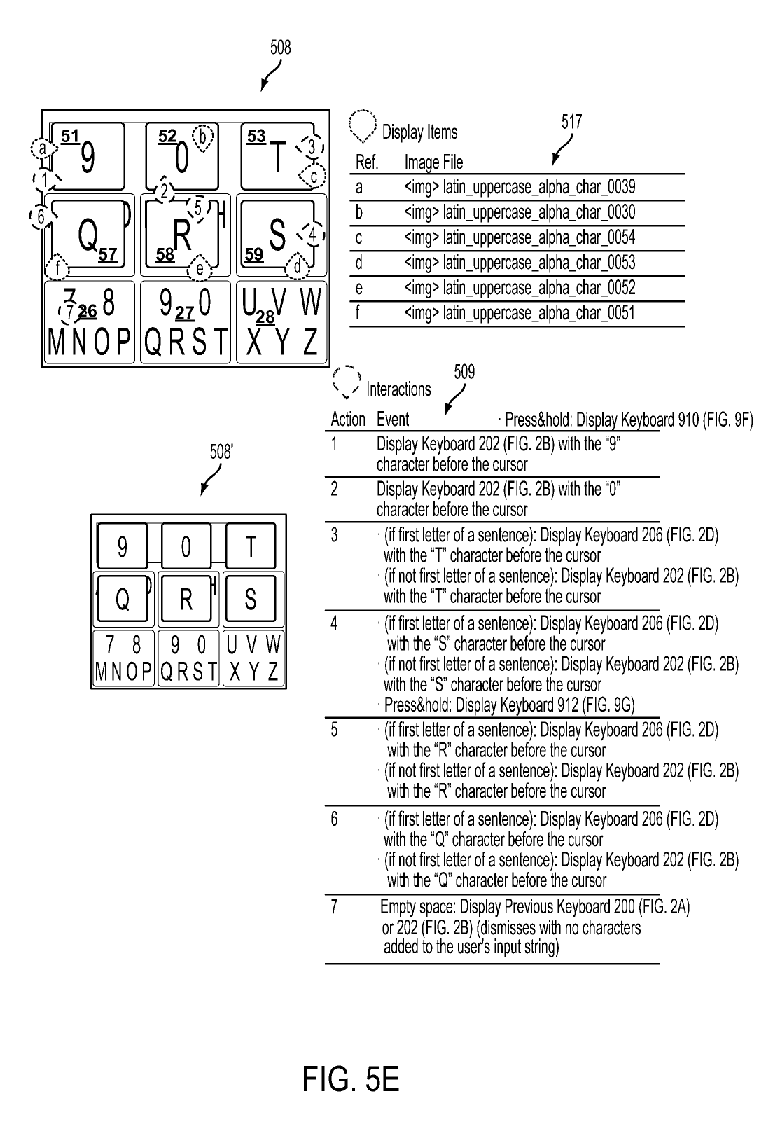

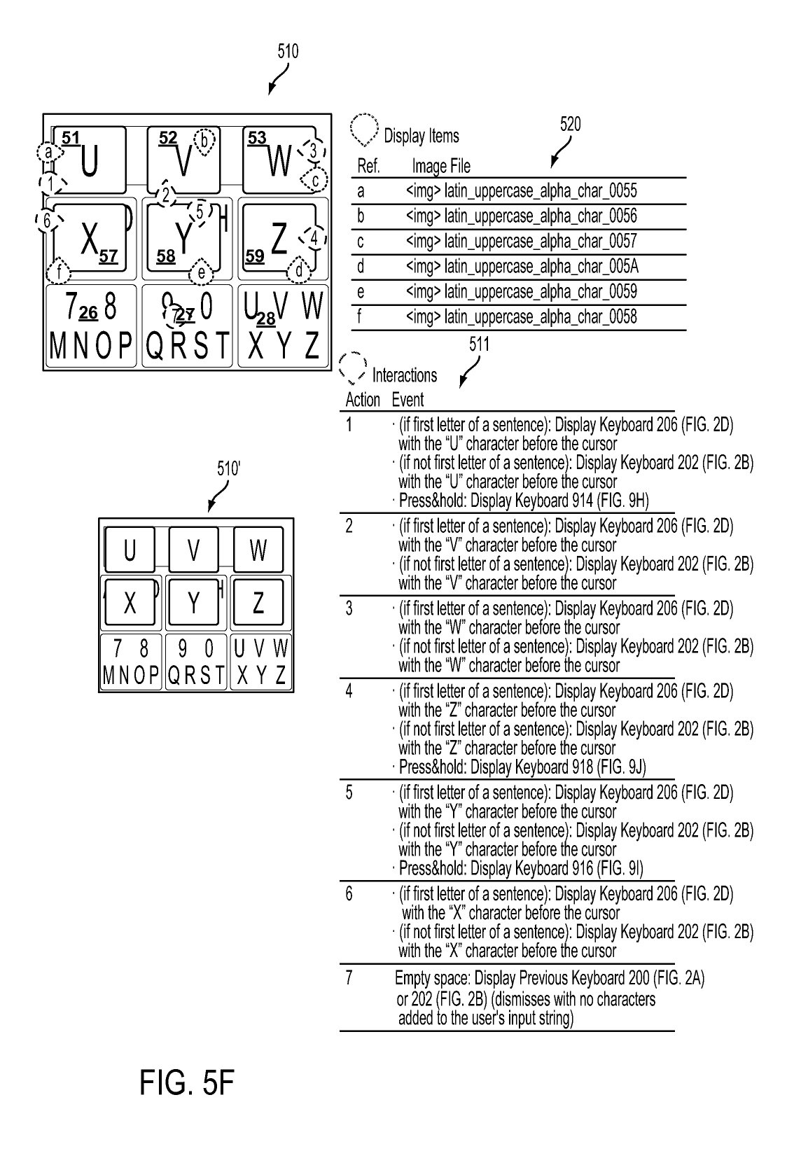

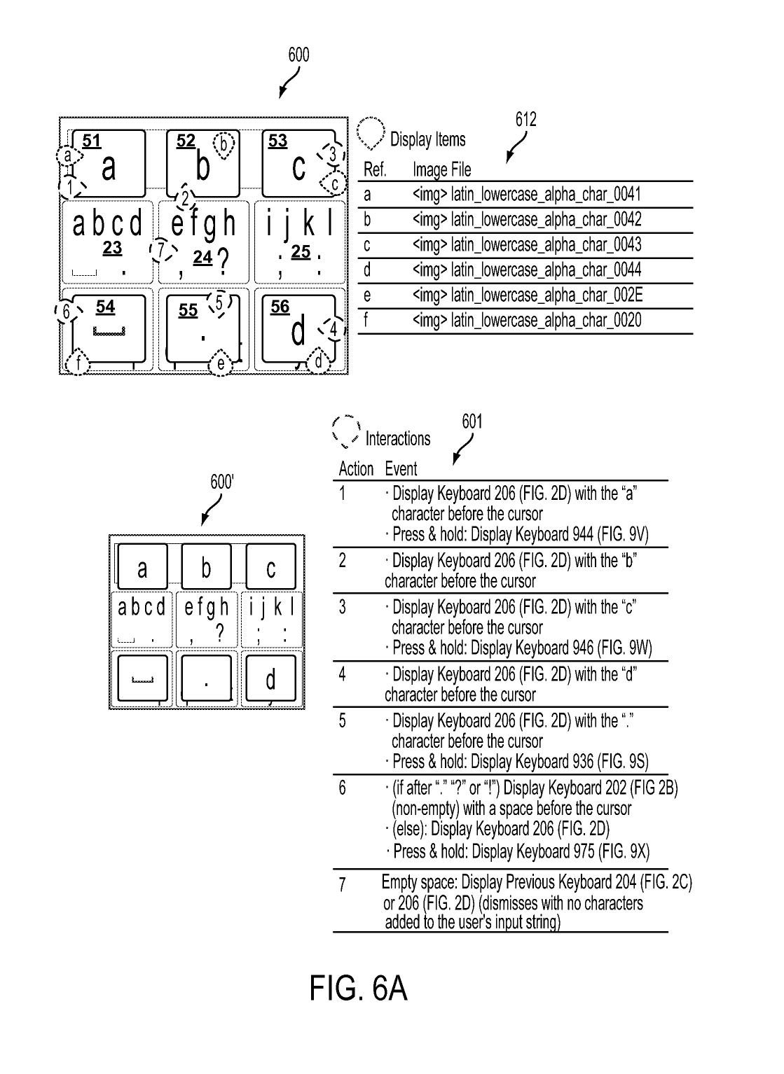

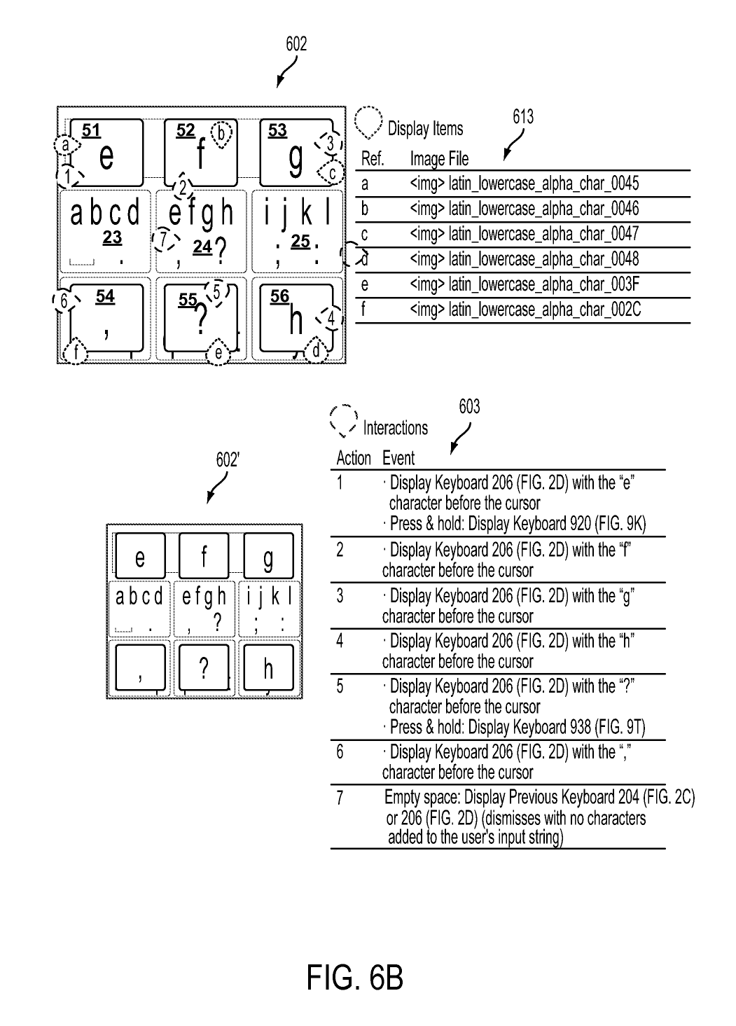

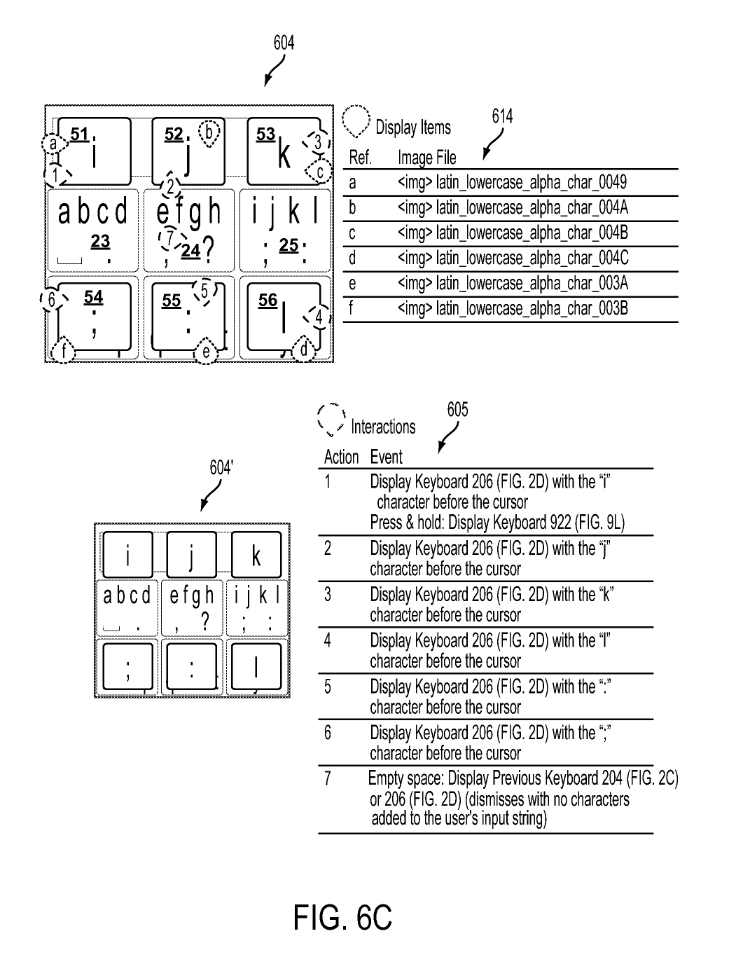

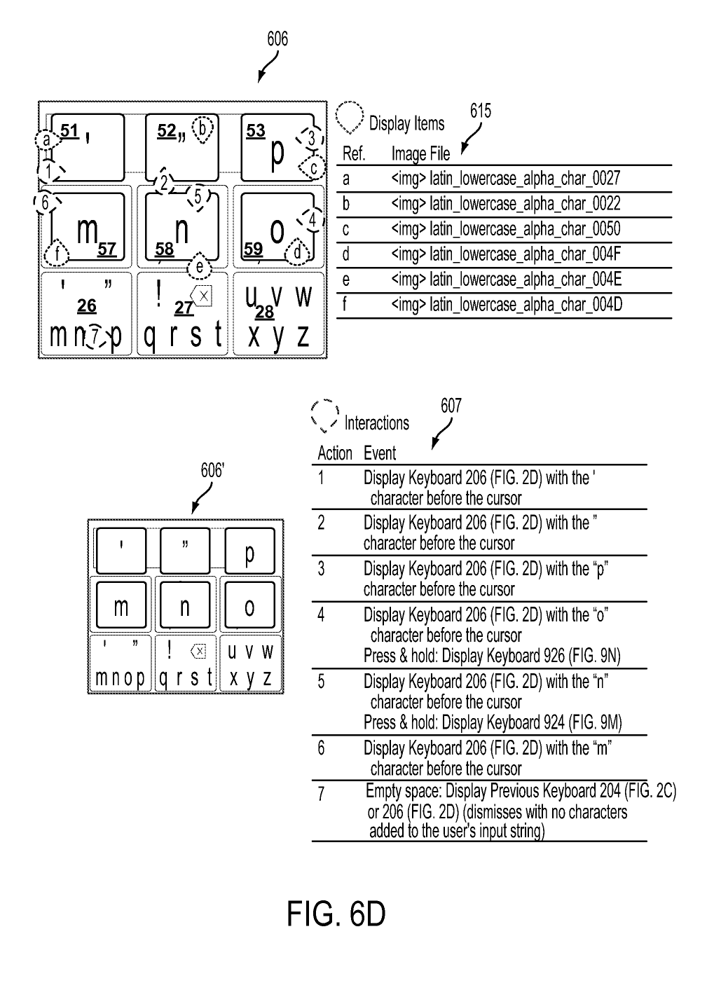

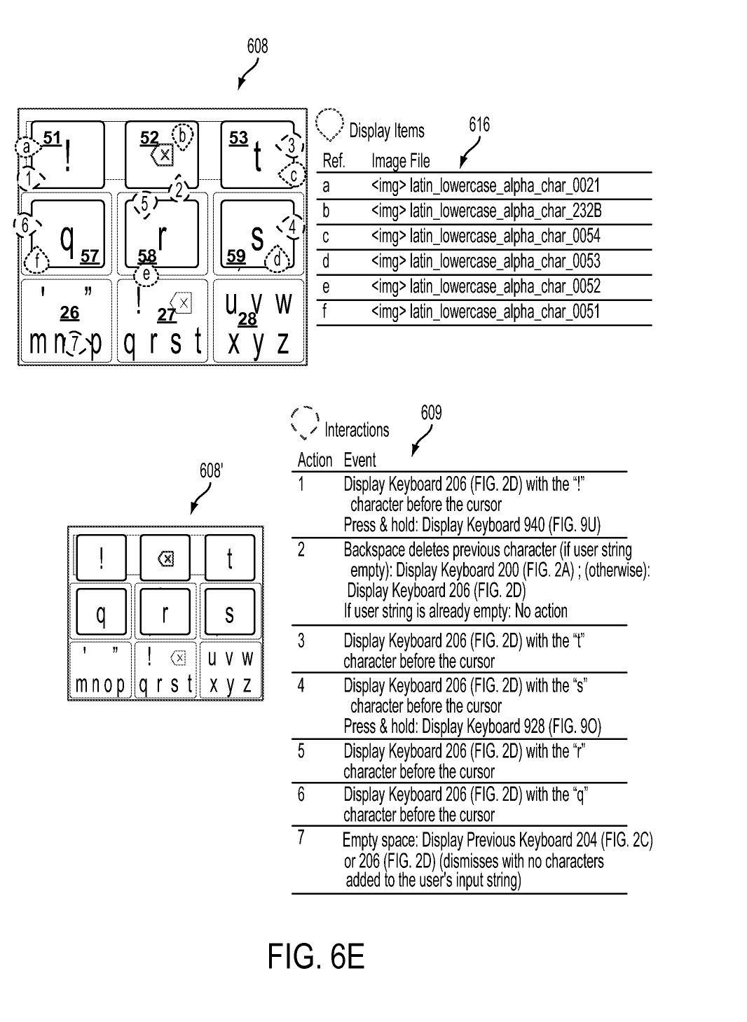

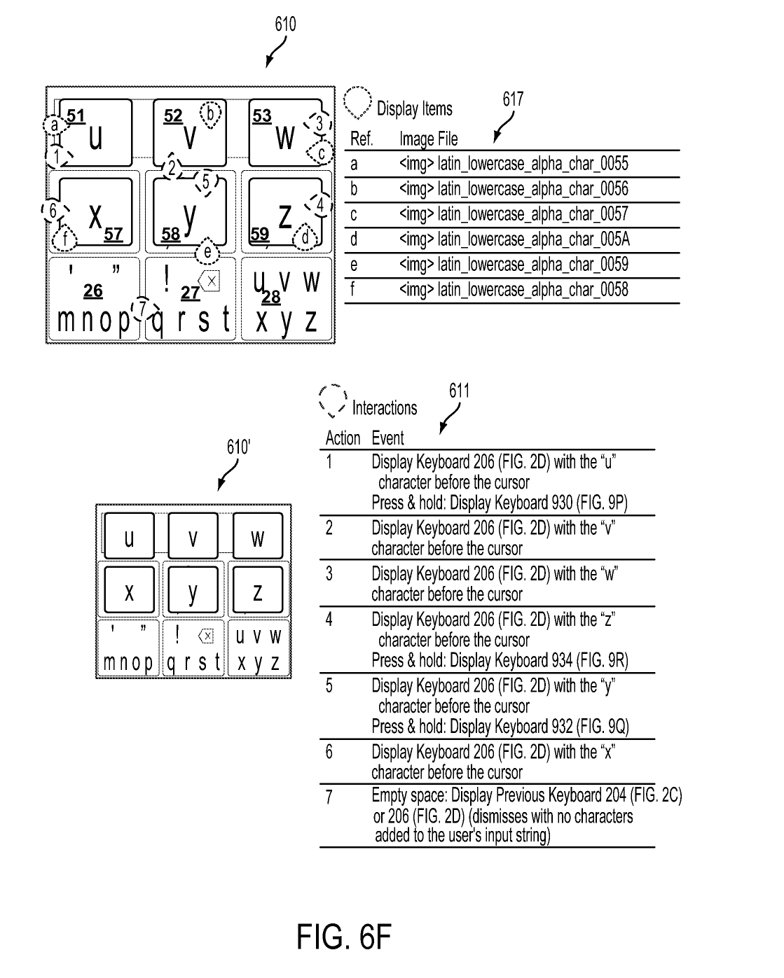

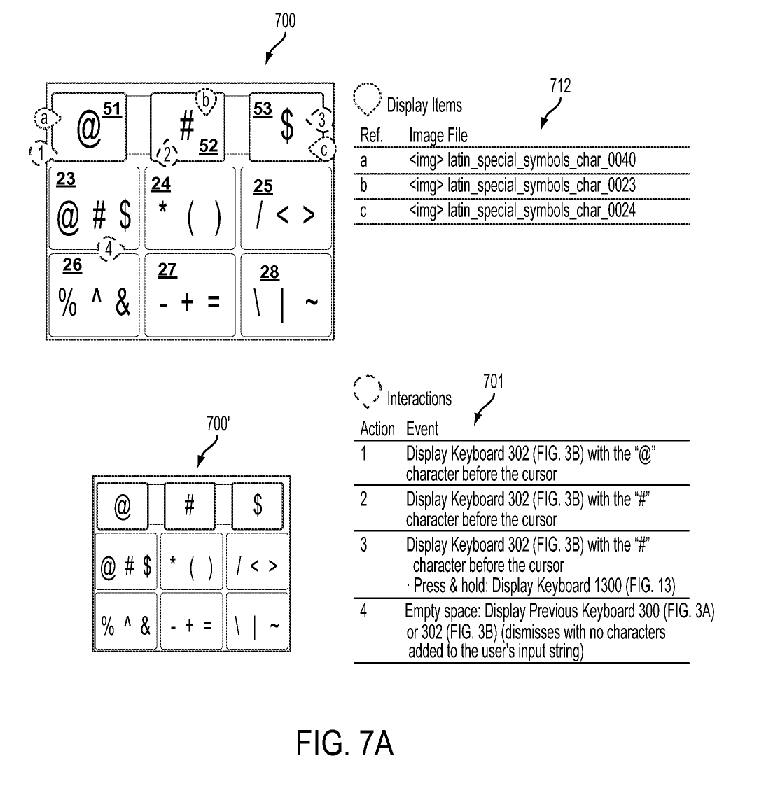

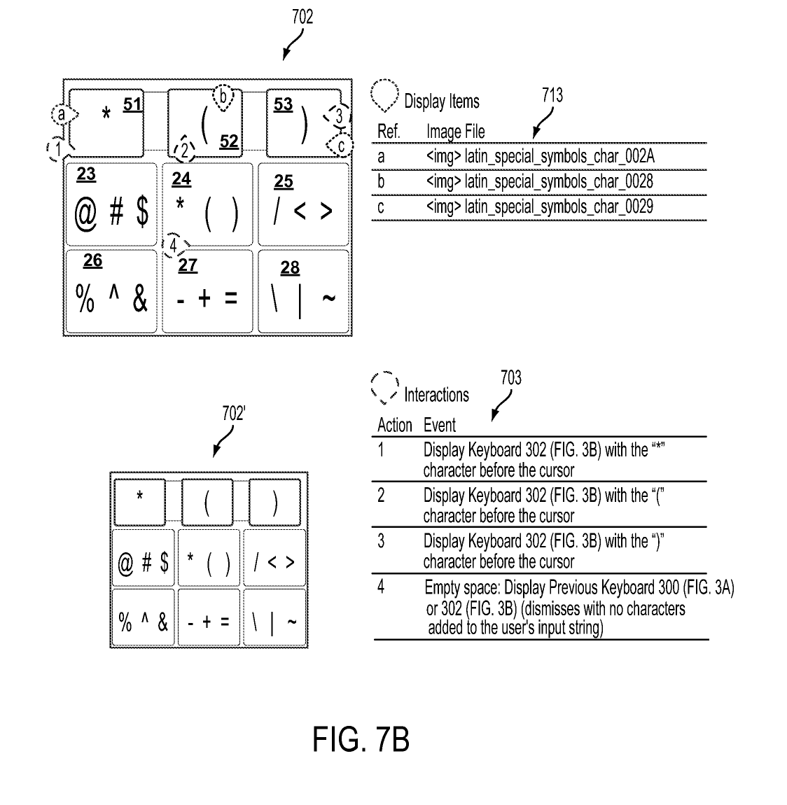

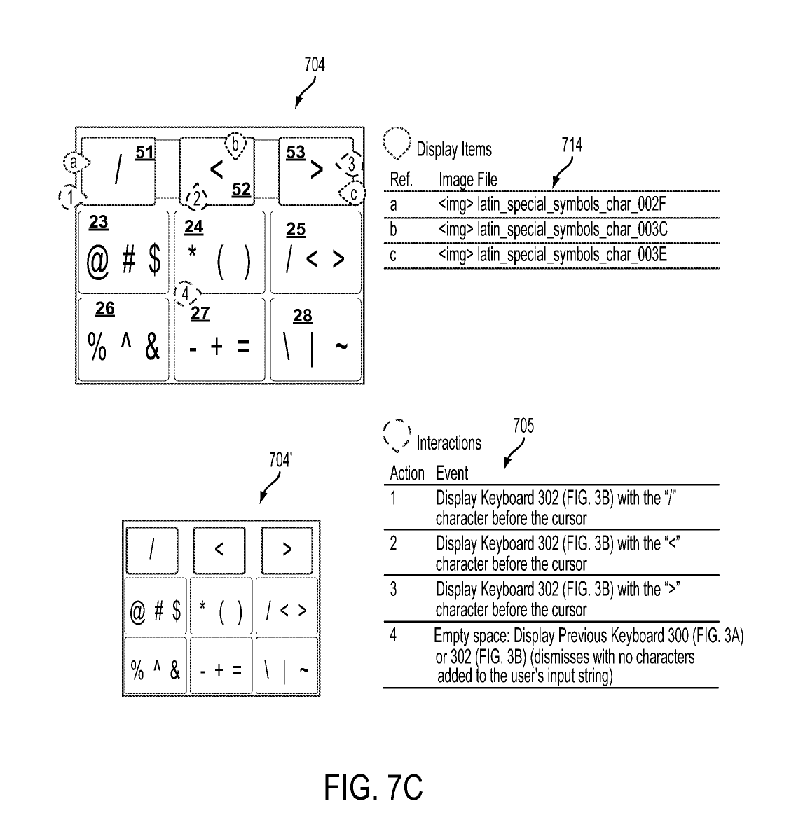

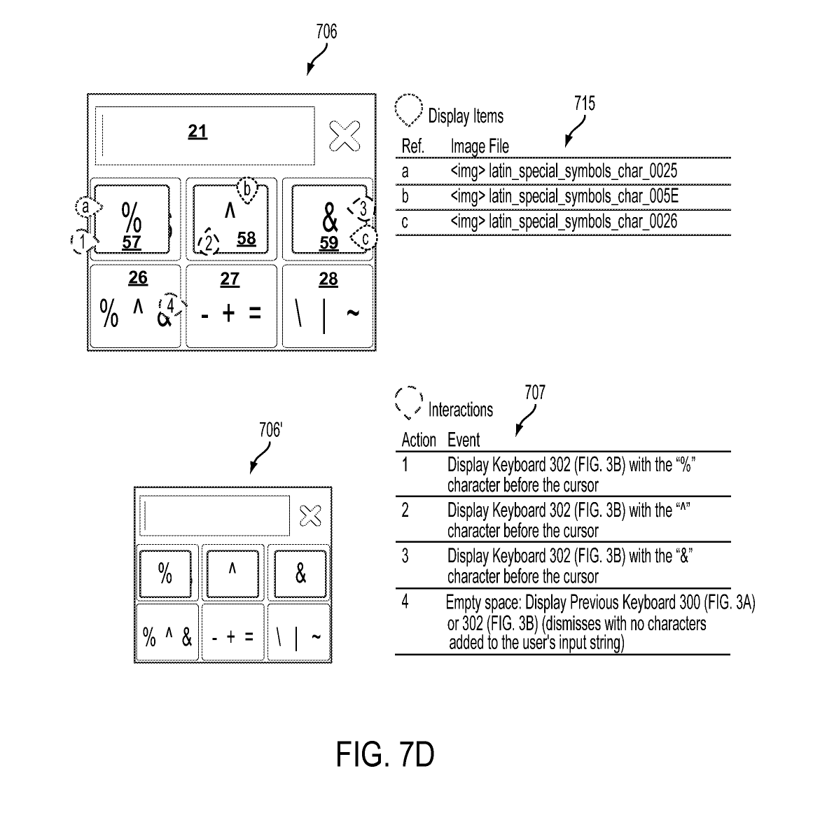

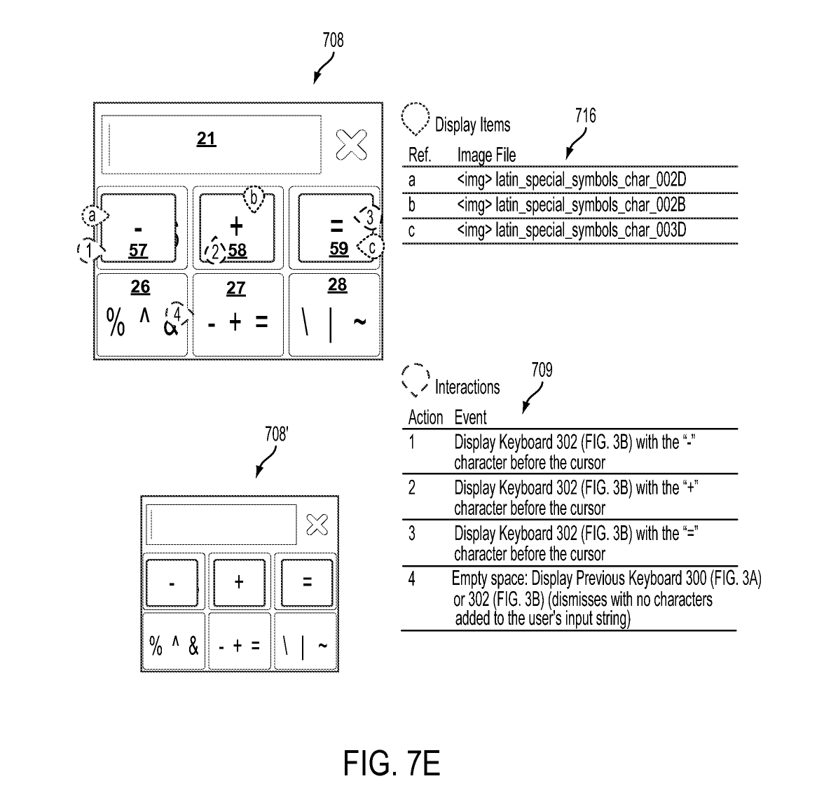

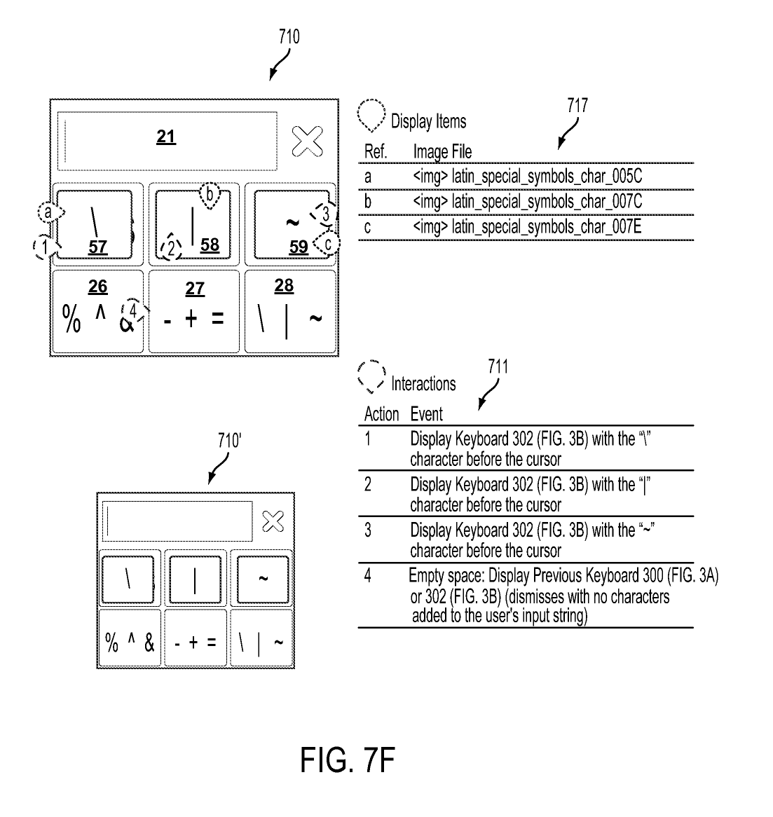

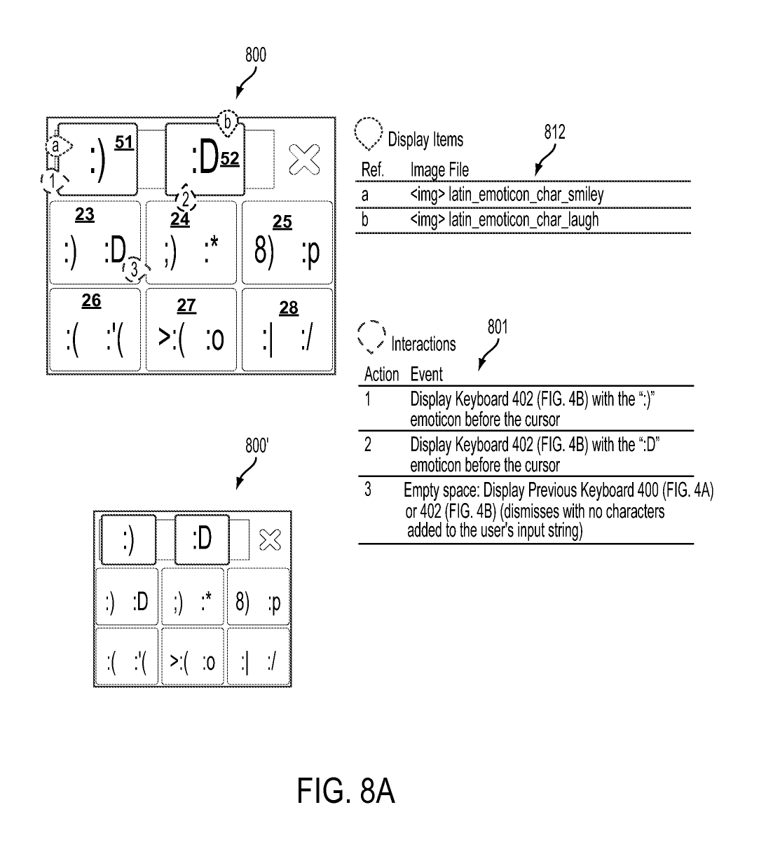

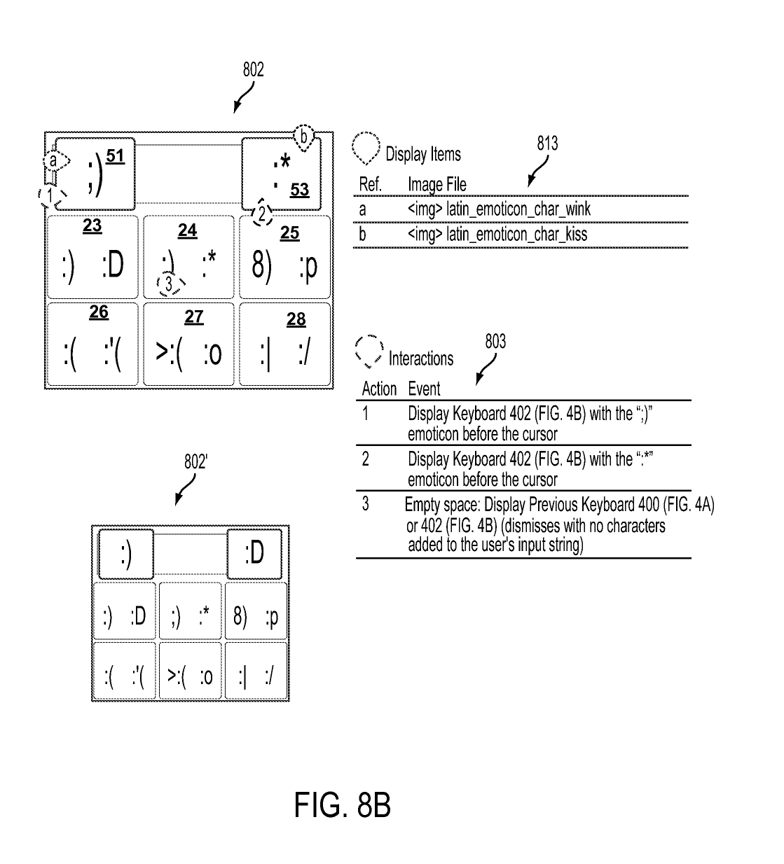

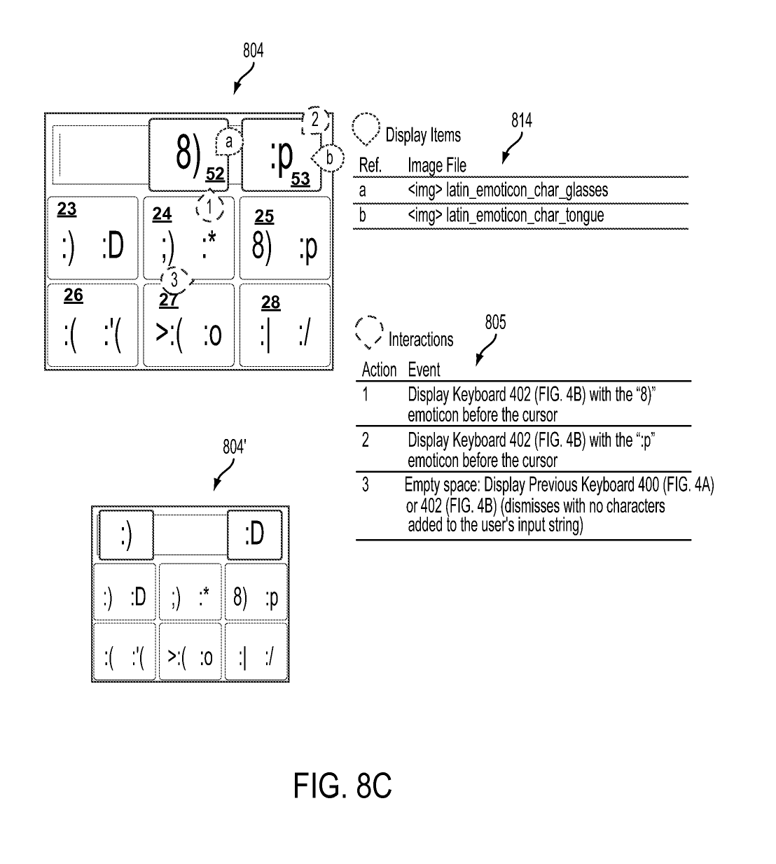

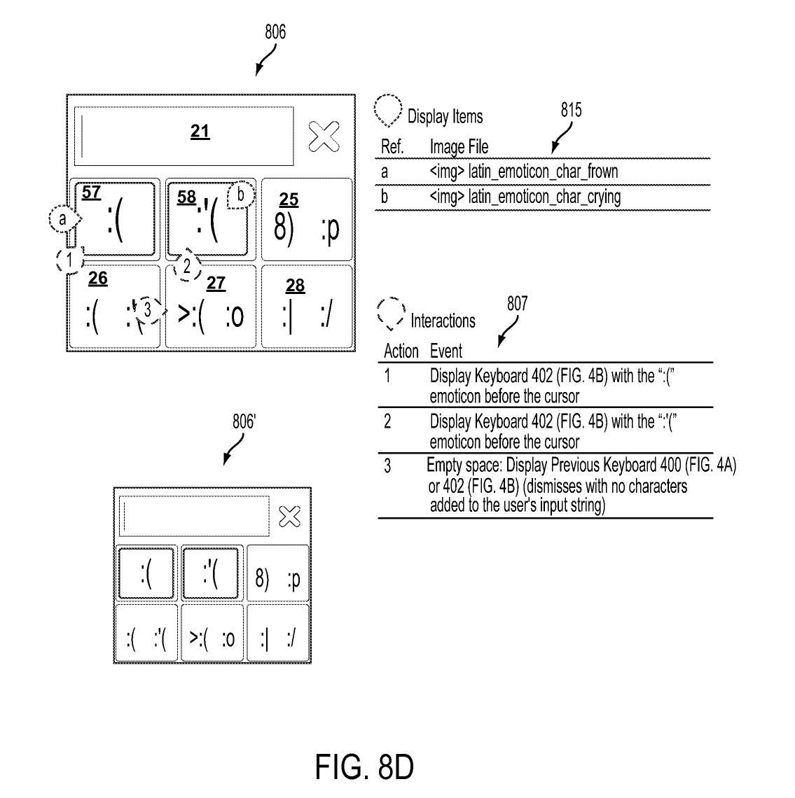

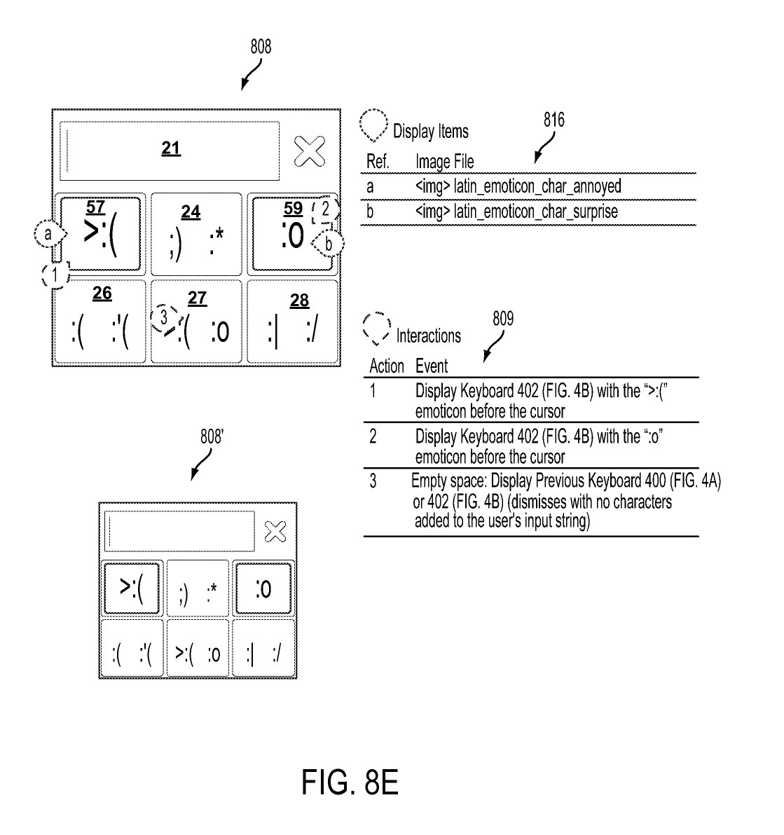

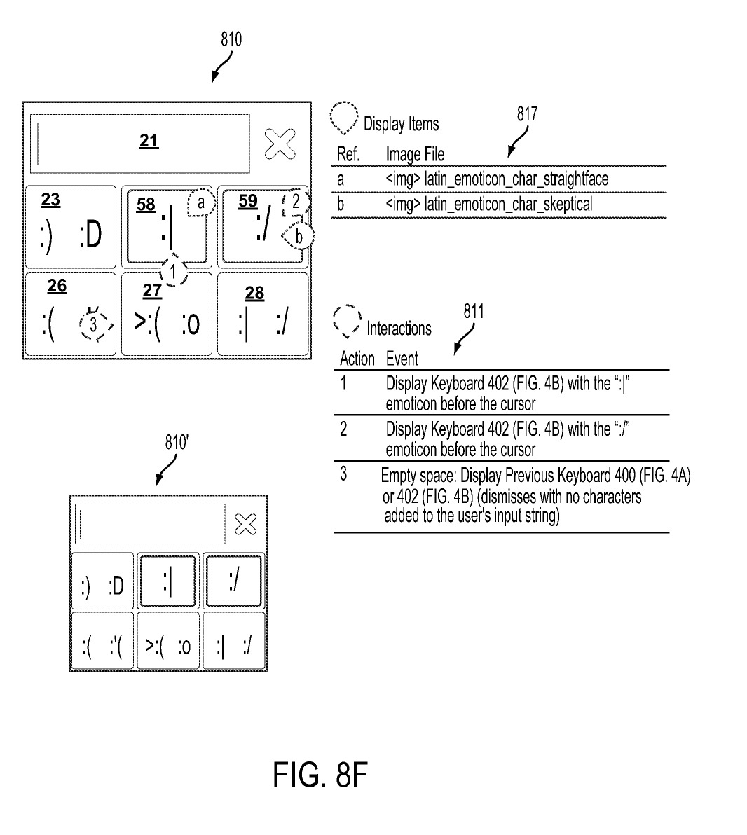

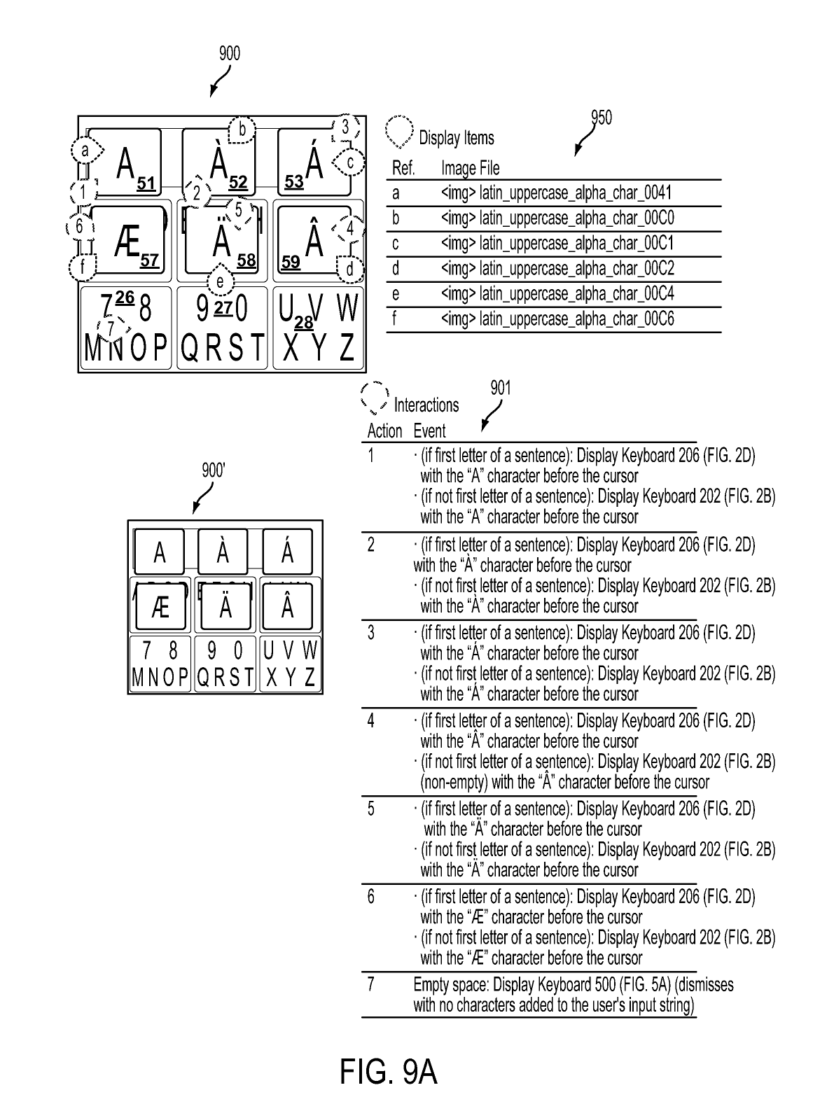

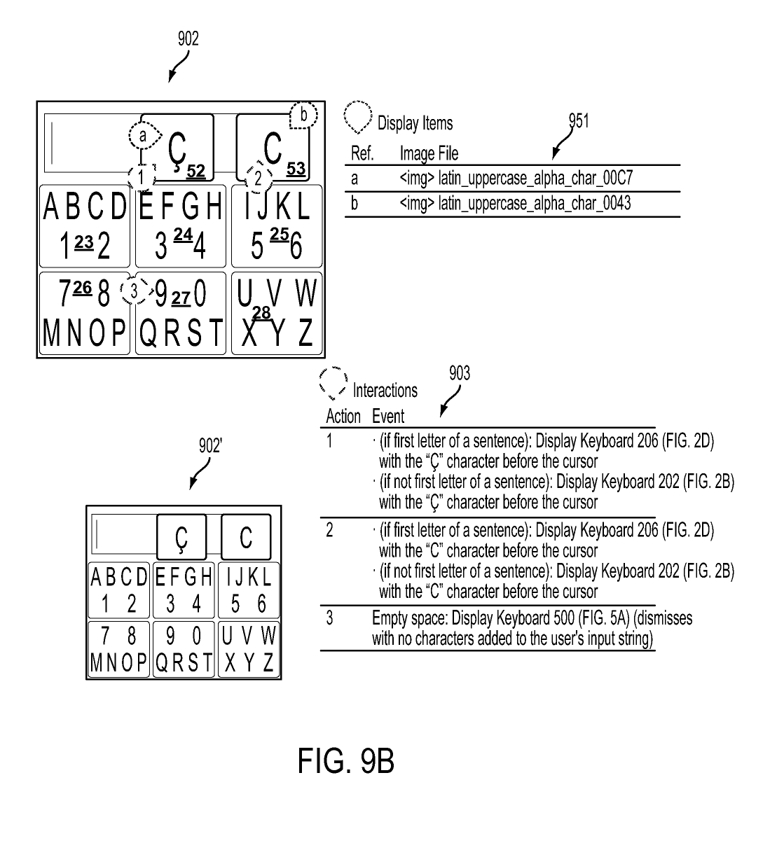

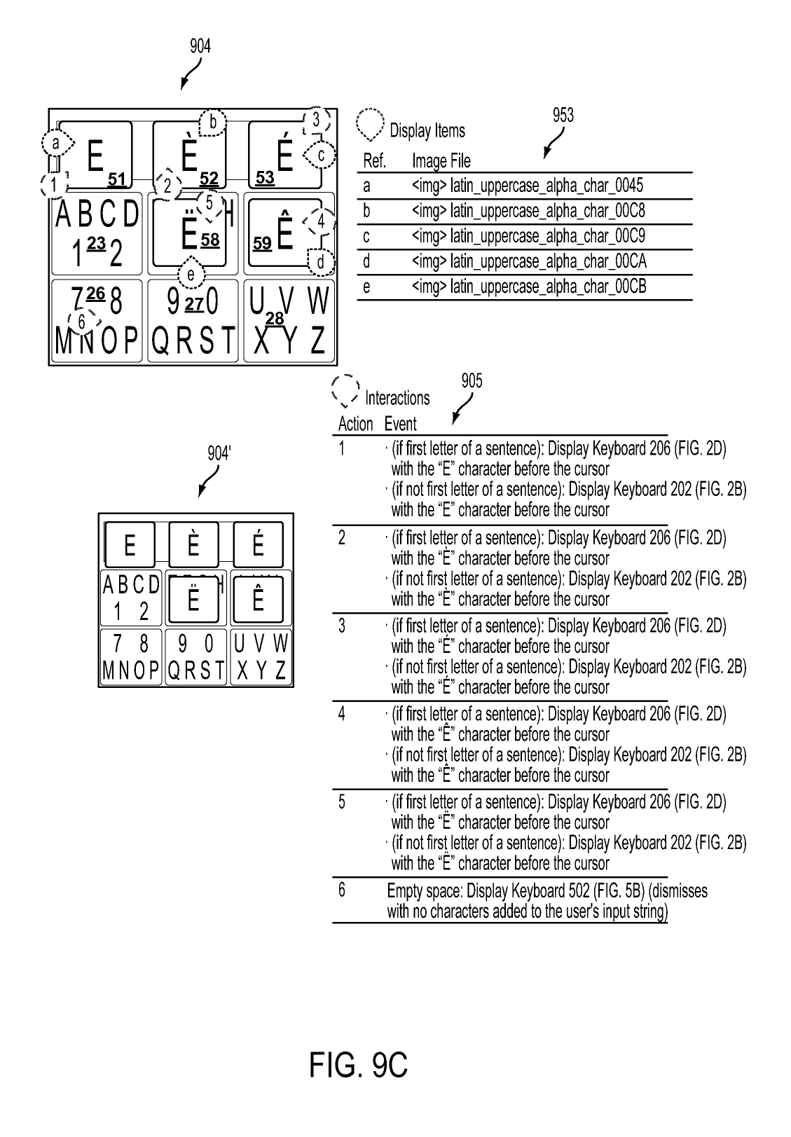

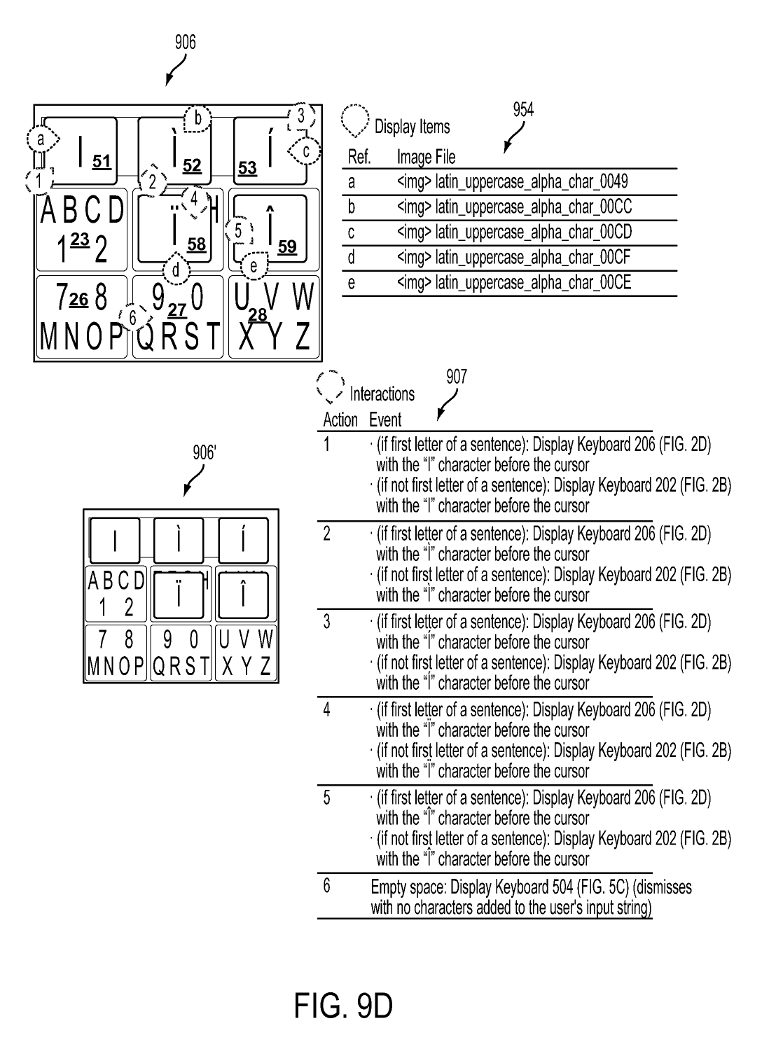

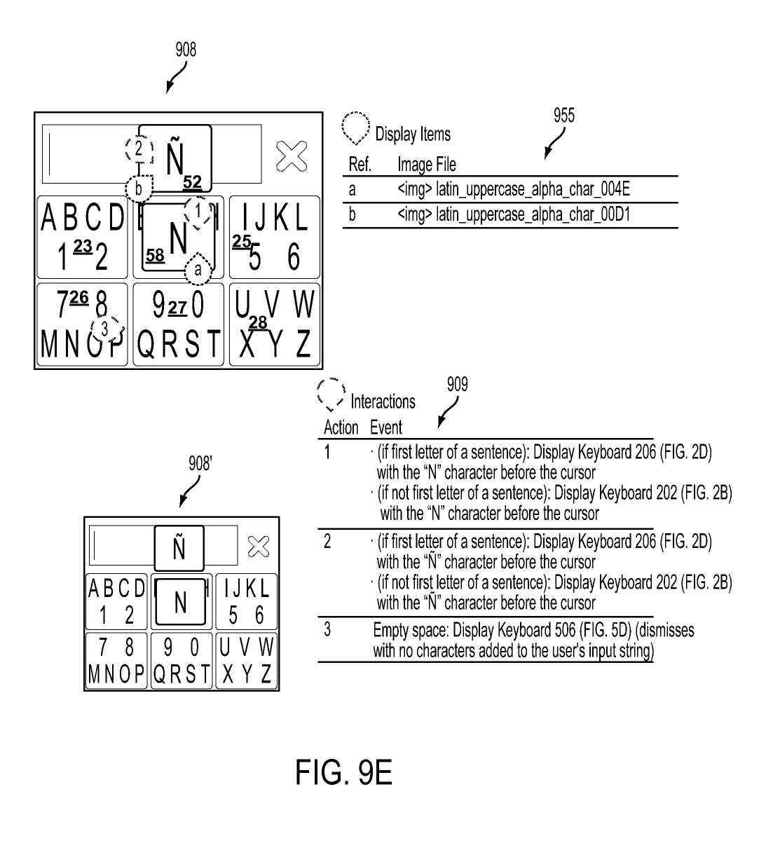

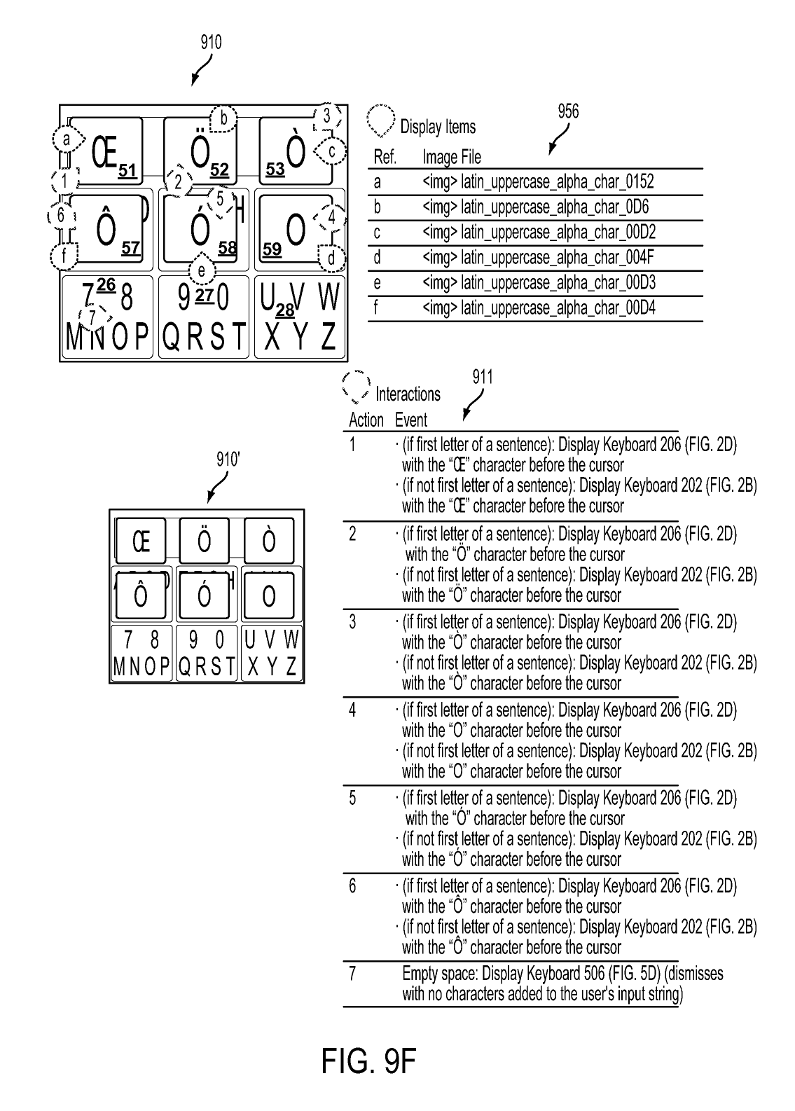

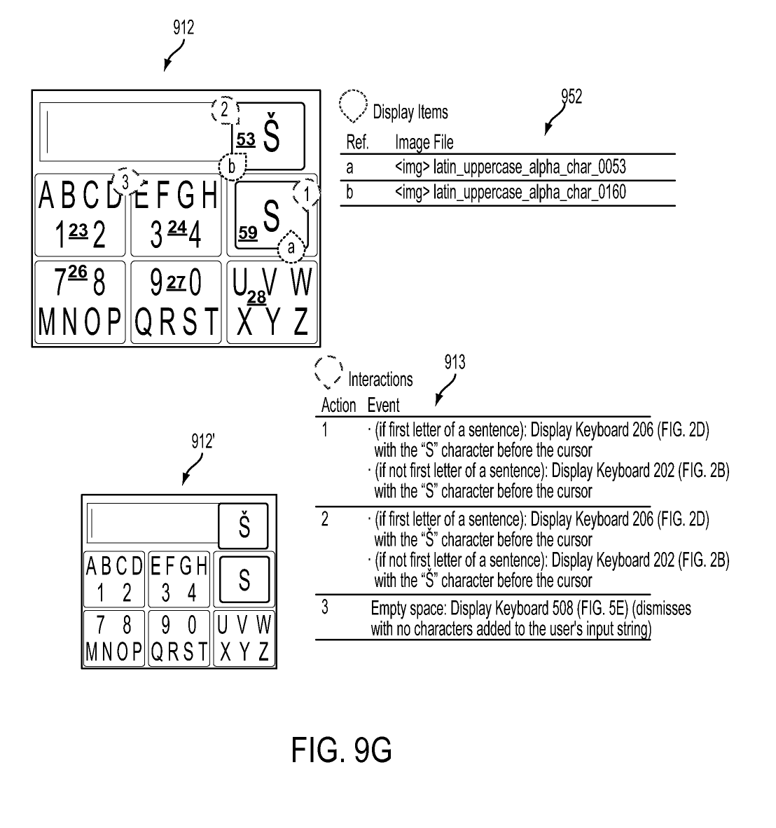

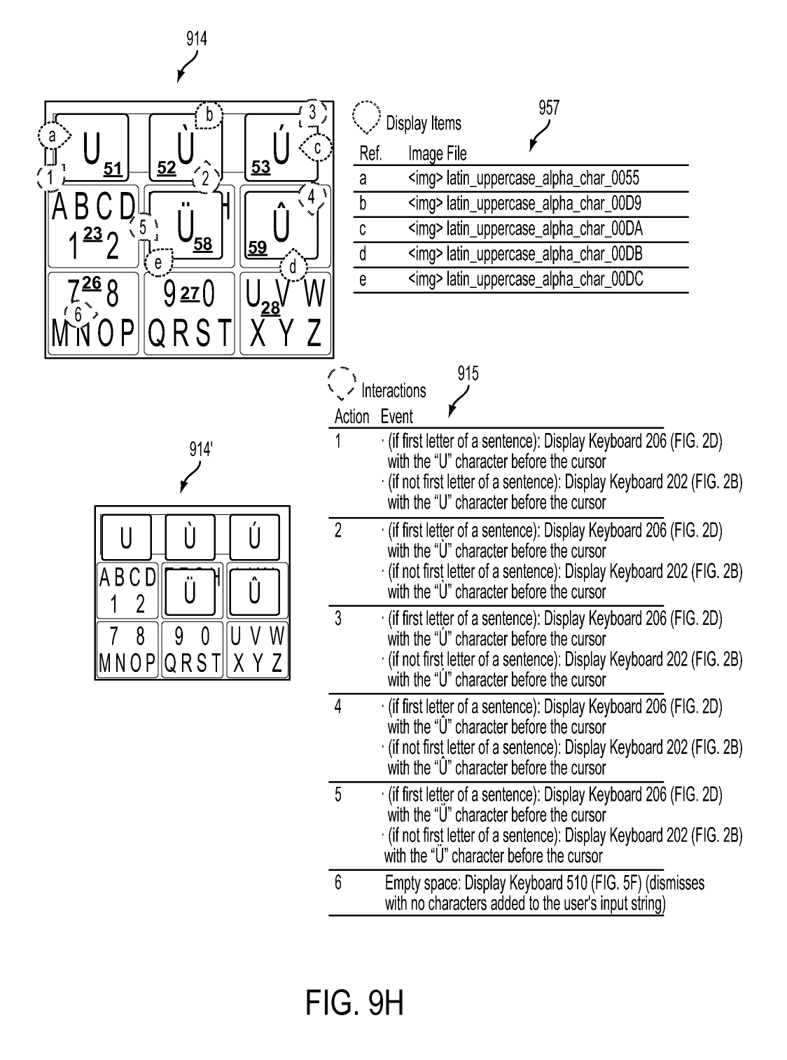

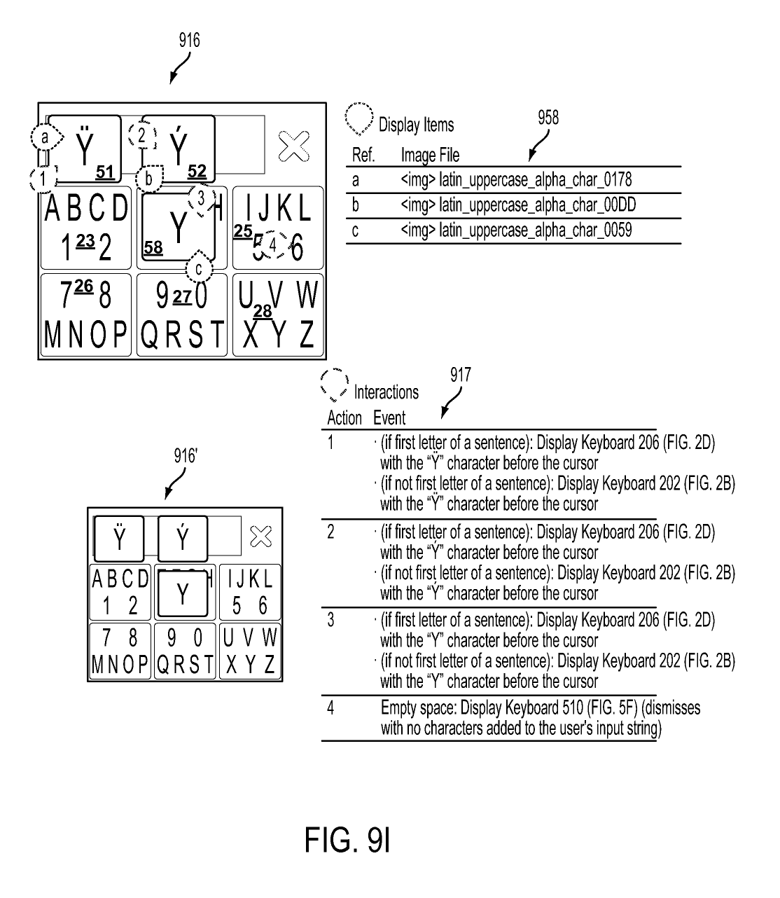

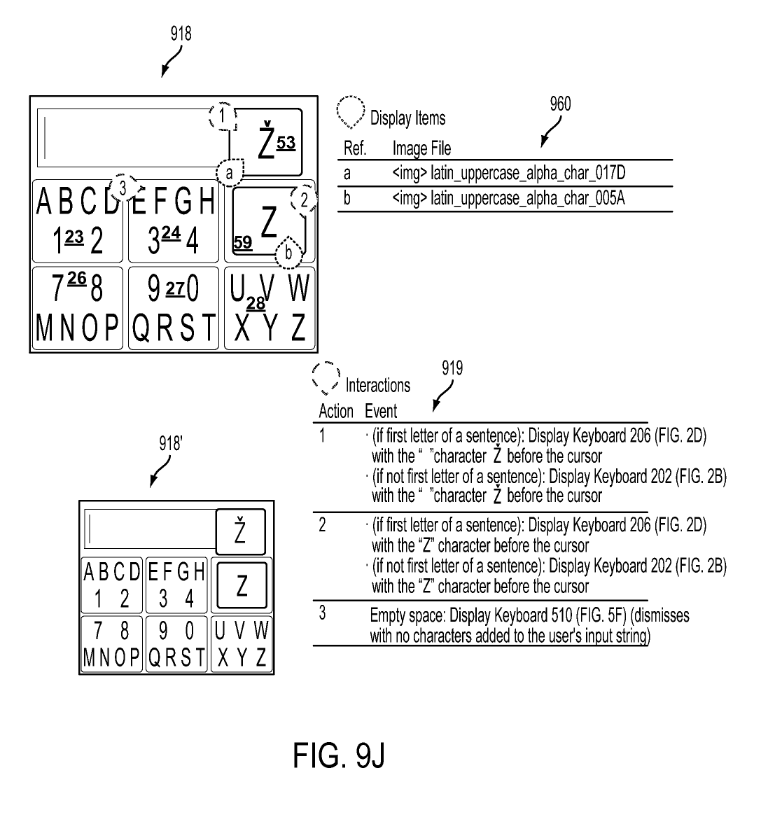

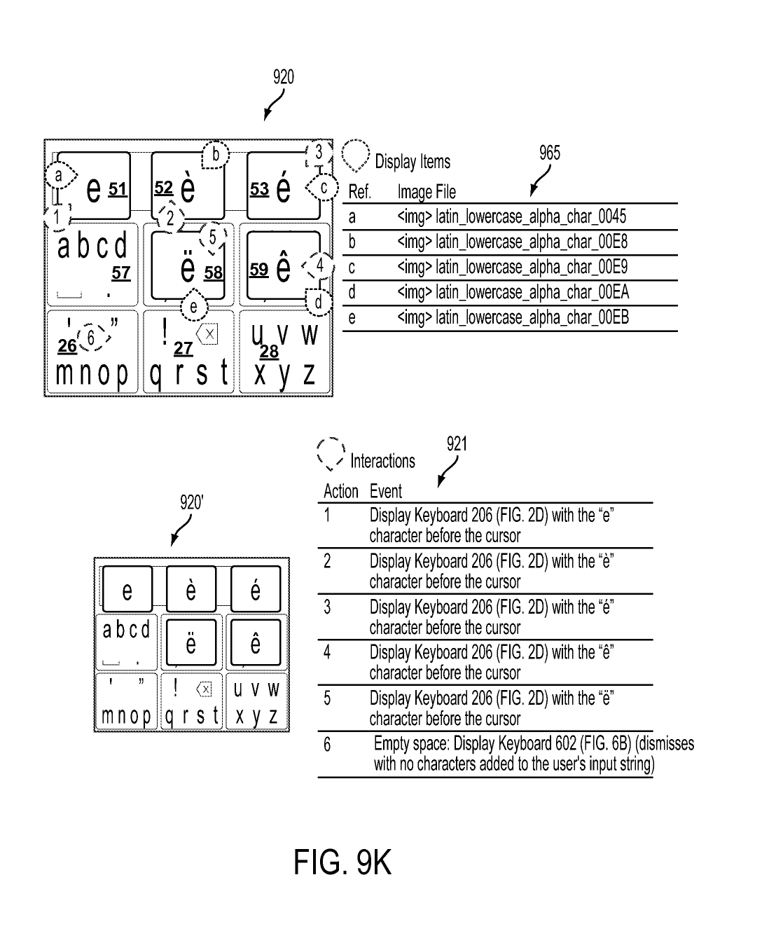

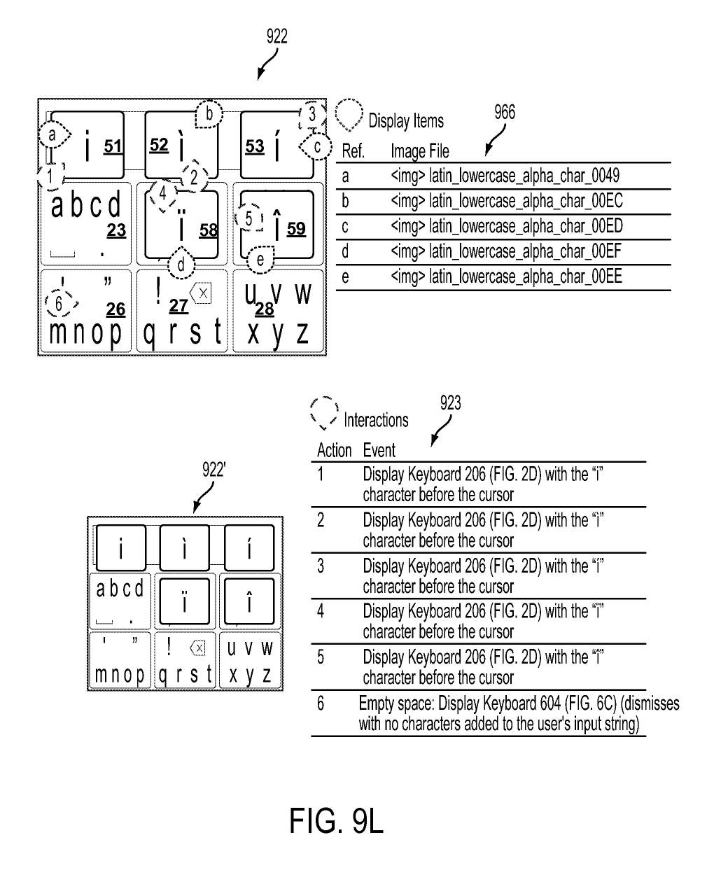

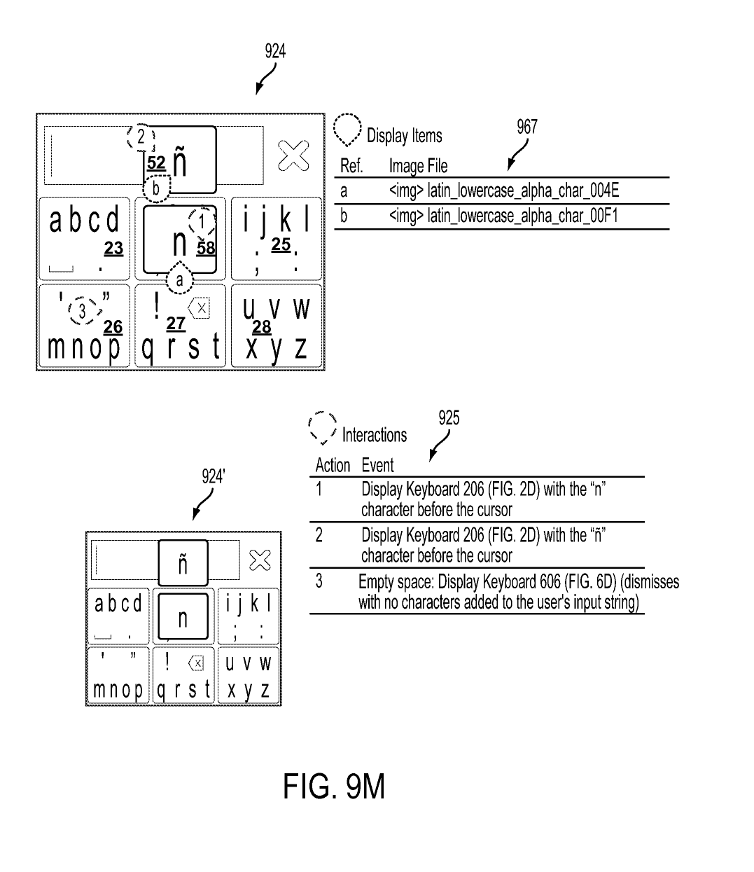

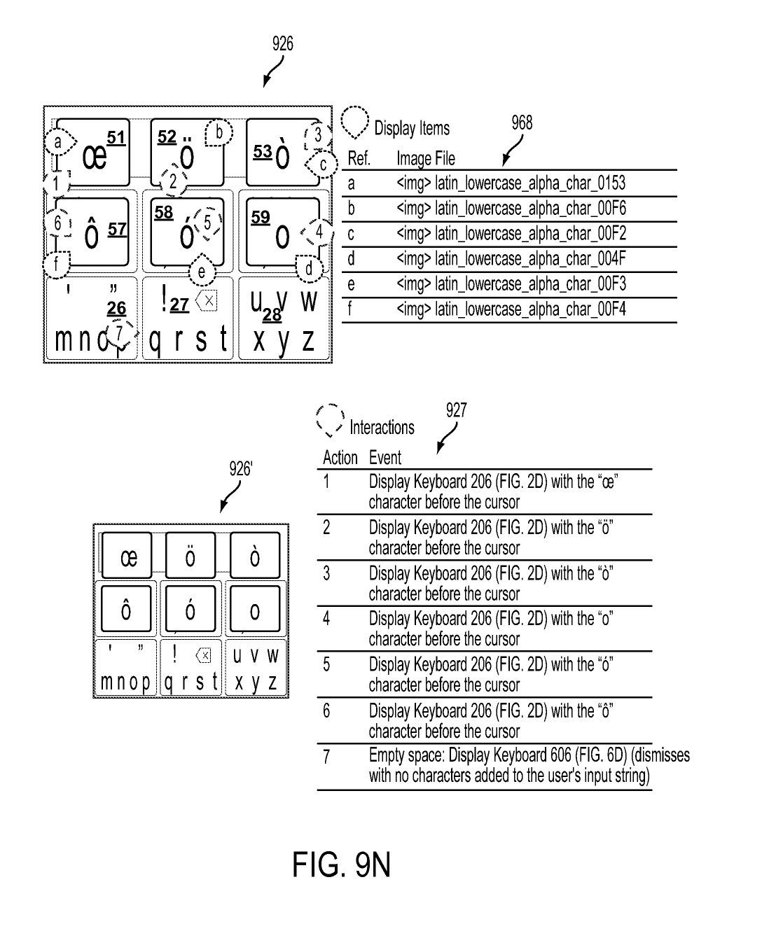

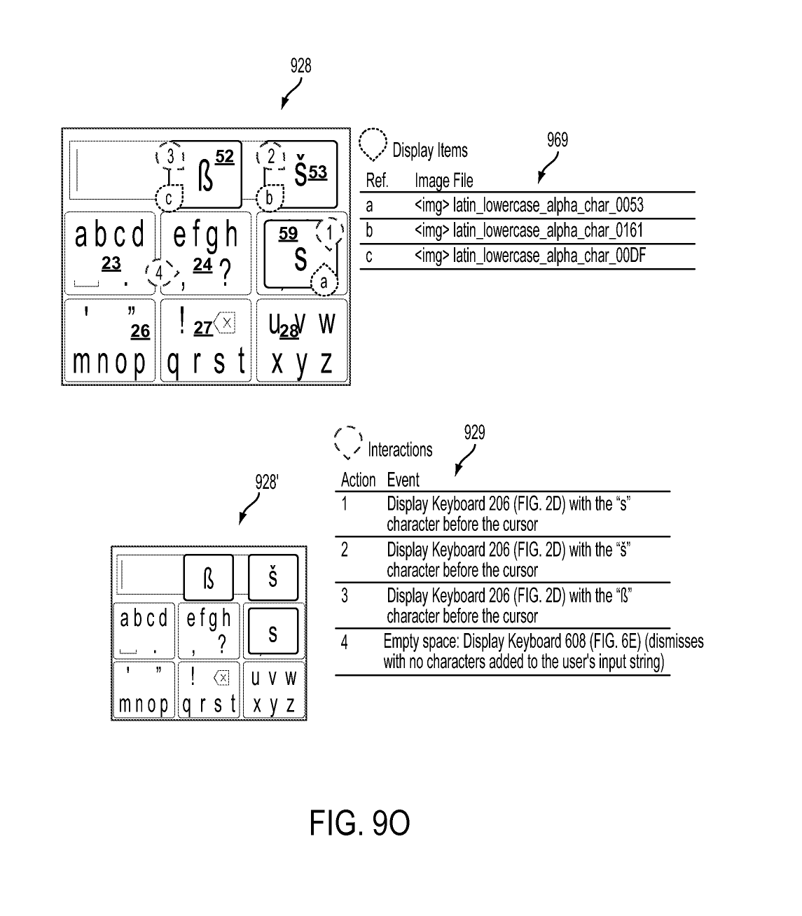

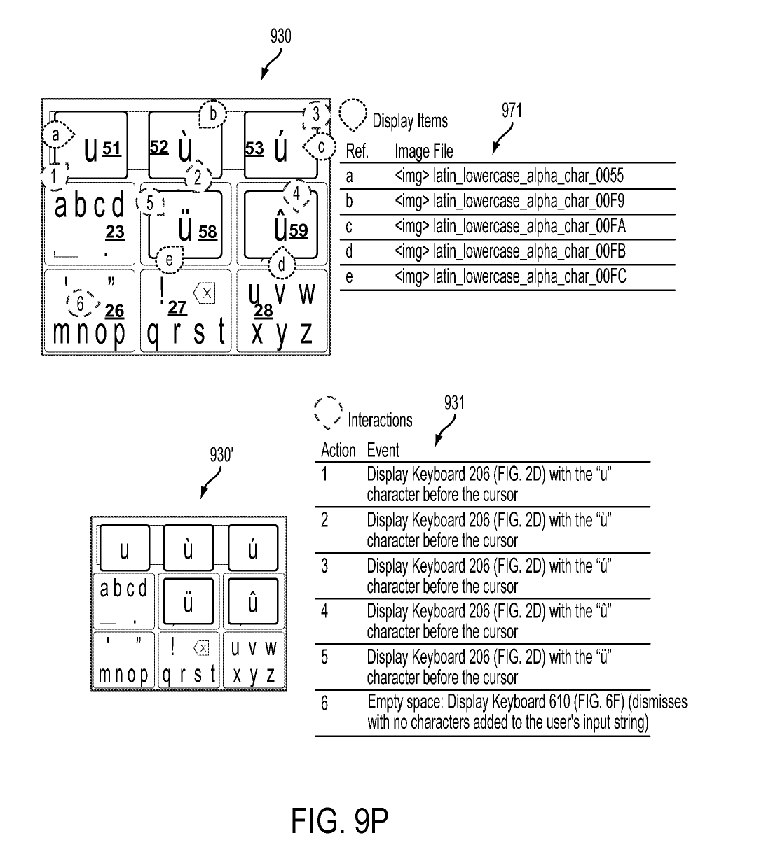

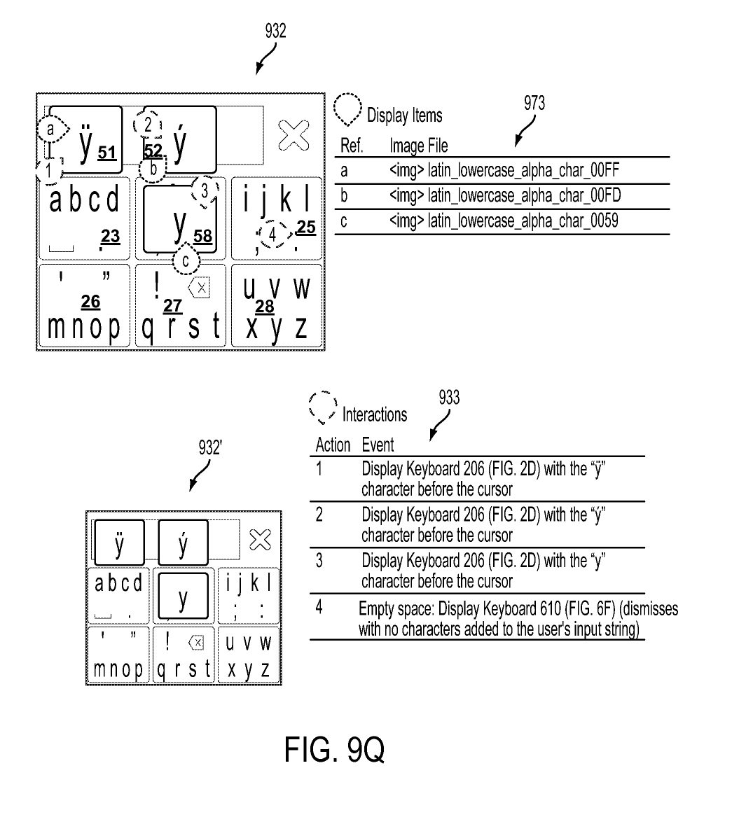

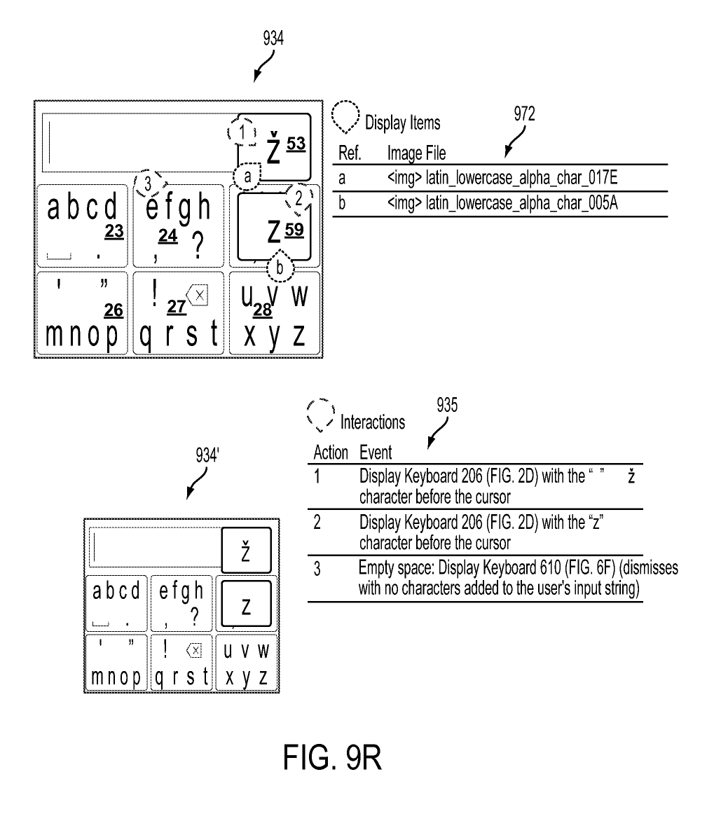

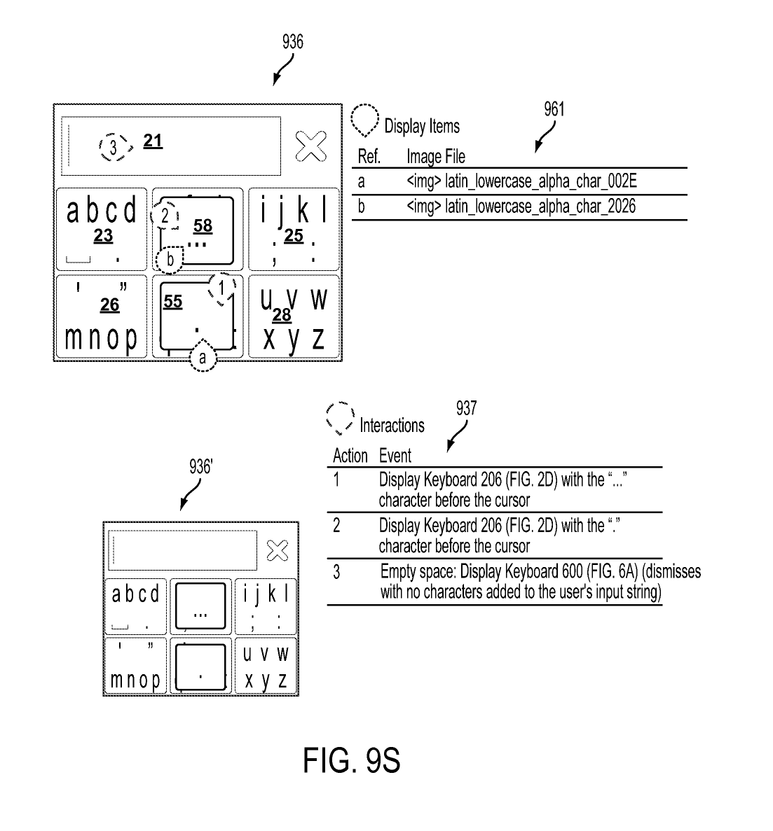

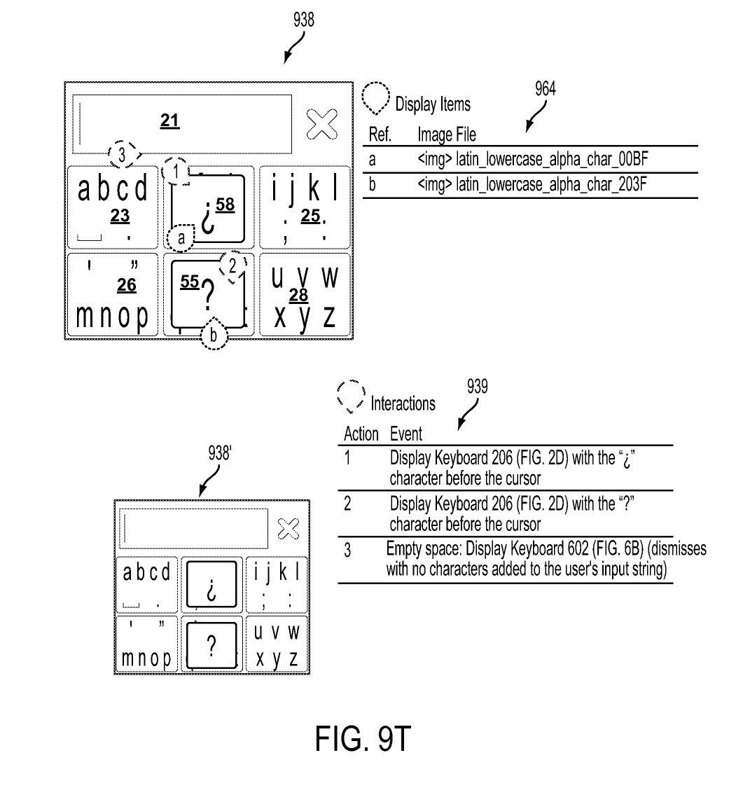

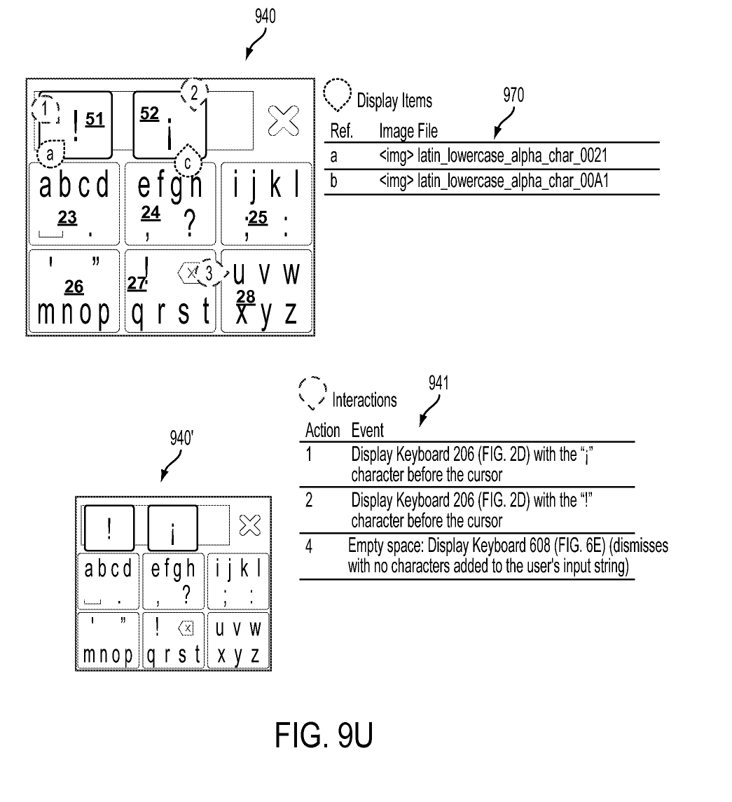

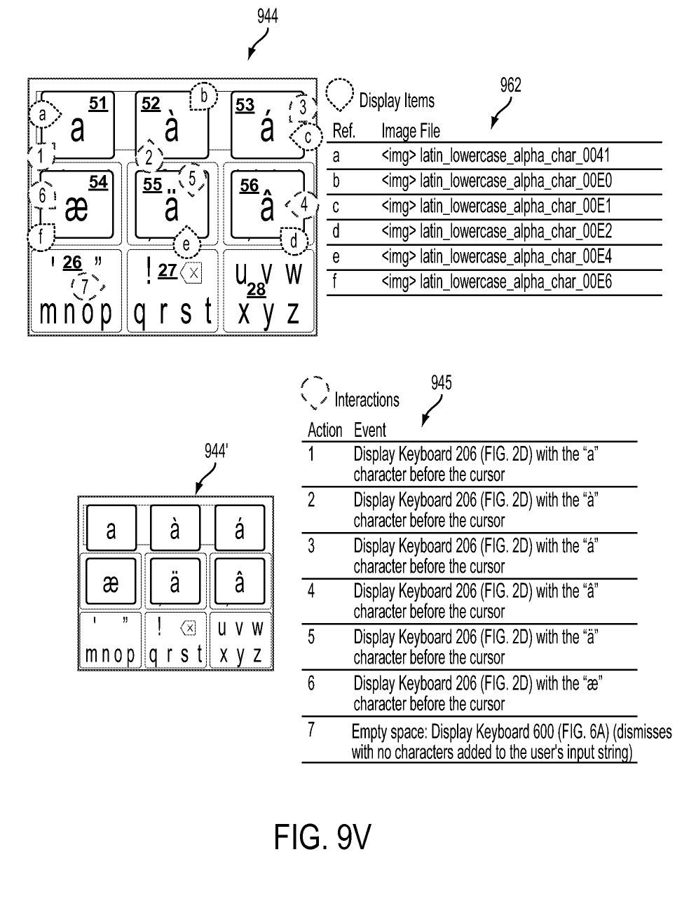

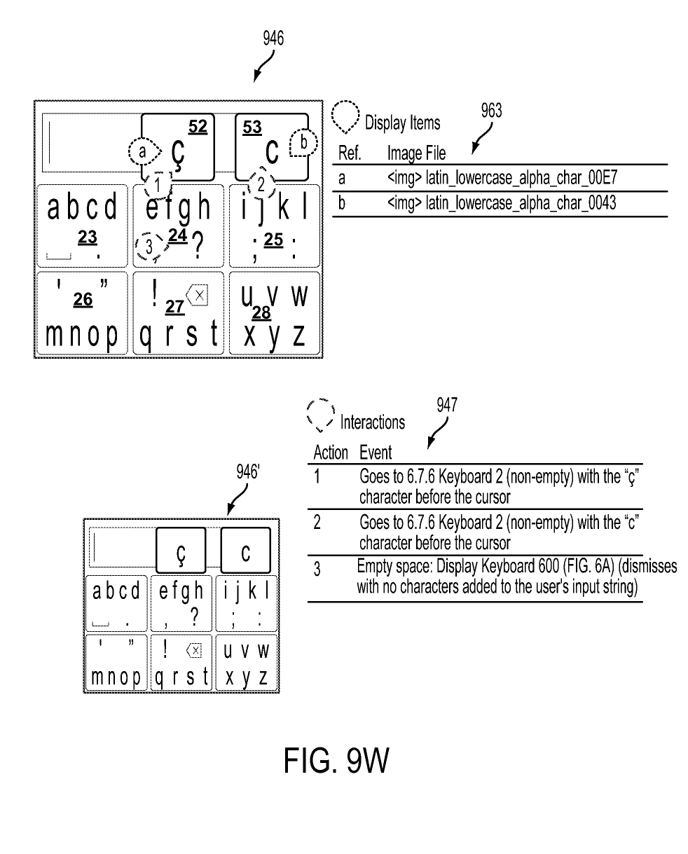

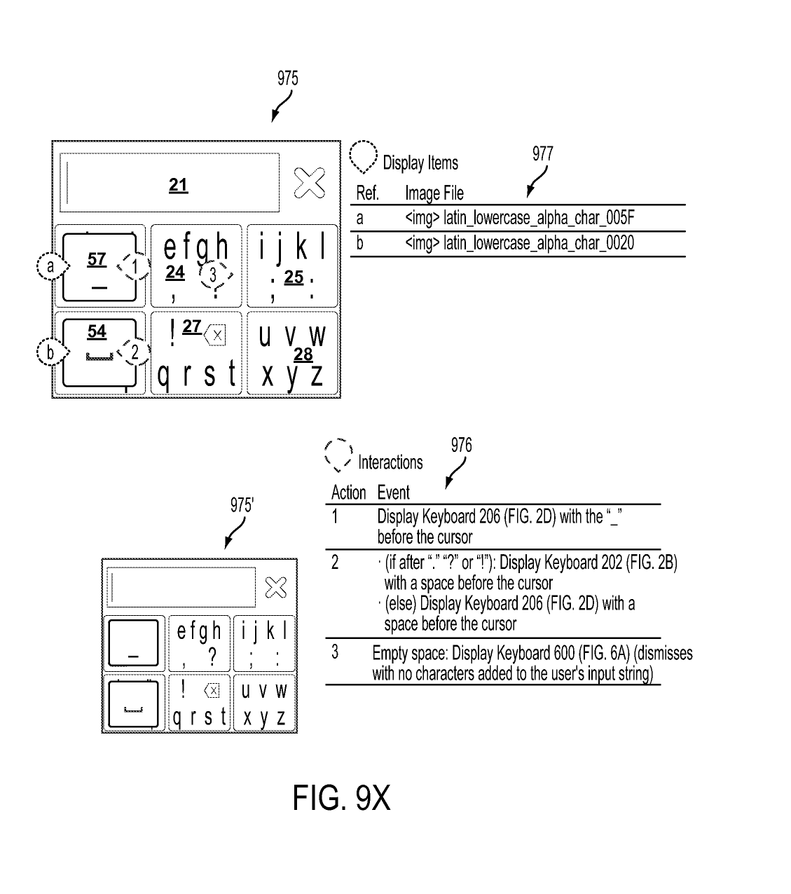

In response to determining the context is not numbers only (i.e., determination block 136=“No”), the processor may select and display a letter based keyboard in block 138. For example, the processor may generate keyboards 200 (FIG. 2A), 202 (FIG. 2B), 204 (FIG. 2C), 206 (FIG. 2D), 300 (FIG. 3A), 302 (FIG. 3B), 400 (FIG. 4A), or 402 (FIG. 4B) as described below.

In block 142 the processor may determine the current displayed keyboard. In block 144 the processor may receive a user input action indication. As examples, user input action indications may be indications of taps, tap and holds, swipes, drags, etc. input by the user to the smart watch 100. In block 146 the processor may determine the text entry area state. As examples, the processor may determine whether characters appear already in the text entry area or whether the text entry area is empty, may determine whether a first character of a sentence corresponds to the cursor location, whether punctuation is present, etc.

In block 148 the processor may determine an event action based on the current displayed keyboard, user input action indication, and text entry area state. As an example, the processor may reference interaction tables as described below with reference to FIGS. 2A-13 (and illustrated in those same figures) to determine an event action to take. As another example, the processor may execute logical tests (e.g., if, then, else type statements, etc.) to determine an event action to take. In block 150 the processor may execute the event action. For example, the processor may execute the event actions as described below with reference to FIGS. 2A-13 (and illustrated in those same figures).

In determination block 152, the processor may determine whether the event action is a close text input action. For example, the processor may determine whether the event action corresponded to an exit “X” button adjacent to a text entry area displayed on the smart watch 100 being selected by the user. In response to determining the event action is not a close text input (i.e., determination block 152=“No”), the processor may receive another user input action by executing operations in blocks 142-150 as described below.

In response to determining the event action is a close text input (i.e., determination block 152=“Yes”), in block 154 the processor may clear (e.g., dismiss) the displayed keyboard and send the character string displayed in the text entry area. For example, the text string may be sent to a requesting program that generated the character entry event indication described below.

FIGS. 2A-13 illustrate an example embodiment of keyboards and interaction tables providing a full keyboard of characters, such as Latin-based characters, that fit on a small touchscreen, such as a touchscreen display 120 of a smart watch 100 described above with reference to FIG. 1A. In general, FIGS. 2A-13 illustrate different keyboards including different button configurations, which may be displayed to a user and the interaction table associated with each keyboard. In the various embodiments, the processor 102 of the smart watch 100 may be configured with processor-executable instructions to generate user interface images to form the keyboards of the embodiments illustrated in FIGS. 2A through 13, to interpret user touches on the touchscreen display 120 as user interactions with virtual buttons and icons according to an interaction table associated with the currently presented keyboard, and to act upon such user interactions by generating a different user interface image of a keyboard or inputting data associated with a touched virtual button as described below with reference to FIGS. 2A through 13. Thus, the processor 102 may determine event actions based on the keyboard displayed shown in FIGS. 2A-13, the user input action indications received based on the user interacting with touchscreen display 120 showing the keyboard, and the text entry area state of the keyboard in FIGS. 2A-13 by using a look up function to select an event action listed in the interaction tables shown in FIGS. 2A-13 associated with each keyboard displayed in FIGS. 2A-13. The interaction tables may correlate user input action indications and text entry area states with event actions.

FIG. 2A illustrates a first keyboard 200 with no characters in the text entry area 21 and its associated interaction table 201. Besides the text entry area 21, the first keyboard 200 (shown at 205 without reference numerals for clarity) includes virtual buttons 23, 24, 25, 26, 27, 28, and an accept icon 22 configured as specified in a display items table 207 associated with the keyboard 200. The display items table 207 may reference various image files stored in memory 104, 106 that the processor 102 may retrieve and render to display the first keyboard 200. As illustrated by the reference letters a-h, each of virtual buttons 23, 24, 25, 26, 27, 28 and accept icon 22 may be associated with its own respective image file. For example, virtual button 23 may be displayed by retrieving an image file “<img>latin_uppercase_alpha_keypad_key_{—}1” from memory 104, 106 and rendering the image file on the touchscreen display 120. By rendering the image files referenced in the display items table 207, the processor 120 may display the first keyboard 200. FIG. 2A also illustrates an interaction table 201 associated with the keyboard 200 that identifies the events that are executed in response to particular actions 1-9 on virtual buttons 23-28, as well as other portions of the keyboard 200.

FIG. 2A also illustrates that the display 200 may include some hint text to guide or prompt a user, which may be turned on (display 206) or off (display 205) by a user. For example, hint text may be a string of characters specified by the program state that necessitated a character entry event. In an embodiment, hint text may only be displayed when the text entry area 21 is empty.

As described above with reference to FIG. 1B, user interactions with displayed virtual buttons 23-28 (e.g., a user putting a finger down to tap, tap & hold, swipe right to left, etc.) prompt the processor 102 to present a different display including a keyboard suitable for the user to make an entry in a small touchscreen interface (e.g., the touch screen display 120 of a smart watch 100). The interaction table 201 associated with the keyboard 200 may function as a look up table for the processor 102 to determine the appropriate next keyboard to display. With each keyboard, there is associated a different interaction table that informs the processor of the proper next keyboard to display and whether and where to place a character input. Thus, FIGS. 2A-13 illustrate one example of how a sequence of small screen displays of different keyboards may be defined and linked together through associated interactions according to the method 130 to generate all possible button inputs within a single display small enough to fit on a small screen, such as touchscreen display 120 of smart watch 100, while presenting virtual buttons that are large enough to be pressed by a user's finger.

For example, according to the interaction table 201, in response to a user tap of the “ABCD12” virtual button 23 (corresponding to action 3 in interaction table 201), the processor 102 will present the keyboard 500 illustrated in FIG. 5A, which presents a set of different virtual buttons, one for each of “A” 51, “B” 52, “C” 53, “D” 56, “1” 54, and “2” 55. (Keyboard 500′ illustrated in FIG. 5A shows the same keyboard 500 without the element numbers for clarity.) These different virtual buttons 51, 52, 53, 54, 55, and 56 may be rendered according to the display items table 515 associated with the keyboard 500 which may reference various image files stored in memory 104, 106 that the processor 102 may retrieve and render to display the keyboard 500. As illustrated in FIG. 5A, the virtual buttons 51-56 are displayed expanded out to portions of the small touchscreen away from the user's previous input action (e.g., the tap on the “ABCD12” virtual button 23) such that the row of virtual buttons 23, 24, and 25 remain visible. In a further embodiment, the displayed area around virtual buttons 51, 52, 53, 54, 55, and 56 may be shown in a different color than virtual buttons 51, 52, 53, 54, 55, and 56, such as gray or any other color, to indicate that the different colored area of the display may be associated with an action different from the virtual buttons 51, 52, 53, 54, 55, and 56 according to the interaction table 501, such as dismissing the keyboard 500.

These individual buttons 51-56 can be pressed (e.g., user finger press and lift on a button, user press and hold of a button, etc.) to enter these letters and numerals according to the instructions in the interaction table 501. The indicated events in the interaction table 501 may include different actions to take based on the state of the text entry area 21. For example, pressing the virtual “D” button 56 (action 4 in the interaction table 501) prompts the processor 102 to present the keyboard 206 illustrated in FIG. 2D including the character “D” before the cursor if the letter is the first of a sentence, or to present the keyboard 202 illustrated in FIG. 2B including the character “D” before the cursor if the letter is not the first of a sentence. The state of the text entry area 21 may be determined to be a first letter of a sentence based on the punctuation in the text entry area 21, such as the character being preceded by a “.”, “?”, or “!” plus a space. Similarly, the user pressing the virtual “A” button 51 (action 1 in the interaction table 501) prompts the processor 102 to present the keyboard 206 illustrated in FIG. 2D including the character “A” before the cursor if the letter is the first of a sentence, or to present the keyboard 202 illustrated in FIG. 2B including the character “A” before the cursor if the letter is not the first of a sentence. Additionally, the user pressing and holding buttons associated with special characters, such as virtual “A” button 51 (action 1 in the interaction table 501) or virtual “C” button 53 (action 3 in the interaction table 501), prompts the processor 102 to present the keyboards 900 or 902 illustrated in FIGS. 9A or 9B, respectively. (Keyboards 900′ and 902′ illustrated in FIGS. 9A and 9B, respectively, show the same keyboards 900 and 902 without the element numbers for clarity.) The different virtual buttons in the keyboards 900 and 902 may be rendered according to their respective display items tables 950 and 951, which may reference various image files stored in memory 104, 106 that the processor 102 may retrieve and render to display the keyboards 900 or 902. These individual buttons in the keyboards 900 and 902 can then be pressed (e.g., user finger press and lift on a button, etc.) to enter these special characters according to the instructions in the interaction tables 901 or 903, respectively. The indicated events in the interaction tables 901 or 903 may include different actions to take based on the state of the text entry area 21. The various actions may result in a selected special character being displayed in the text entry area 21 and, based on the state of the text entry area 21, the processor 102 may display the keyboards 202 (FIG. 2B) or 206 (FIG. 2D) or return to displaying keyboard 500 (FIG. 5A) according to the instructions in the tables 901 or 903, respectively.

As illustrated in FIG. 2A, different user interactions with virtual buttons 23, 24, 25, 26, 27, and 28 may the cause that the processor 102 to render different keyboards 500 (FIG. 5A), 502 (FIG. 5B), 504 (FIG. 5C), 506 (FIG. 5D), 508 (FIG. 5E), or 510 (FIG. 5F). As illustrated in FIGS. 5A-5F, each of the subsequent displayed keyboards 500, 502, 504, 506, 508, or 510 (also shown as 500′, 504′, 506′, 508′, or 510′ without reference numerals for clarity) may present a series of virtual buttons 51, 52, 53, 54, 55, 56, 57, 58, and/or 59 expanded out to portions of the small touchscreen away from the user's previous input action such that the row of virtual buttons 23, 24, 25 or 26, 27, 28 associated with the virtual button selected by the user remains visible. Displayed keyboards 500, 502, 504, 506, 508, or 510 may each be associated with their respective display items tables 515-520, which reference various image files stored in memory 104, 106 that the processor 102 may retrieve and render to display the keyboards 500, 502, 504, 506, 508, or 510. Displayed keyboards 500, 502, 504, 506, 508, or 510 may also be associated with their own respective interaction tables, 501, 503, 505, 507, 509, and 511 that indicate to the processor 102 different actions to take based on the state of the text entry area 21. These actions may include entering text in the text entry area 21 and rendering keyboard 202 (FIG. 2B) or 206 (FIG. 2D), rendering special character keyboards 900 (FIG. 9A), 902 (FIG. 9B), 904 (FIG. 9C), 906 (FIG. 9D), 908 (FIG. 9E), 910 (FIG. 9F), 912 (FIG. 9G), 914 (FIG. 9H), 916 (FIG. 9I), or 918 (FIG. 9J), or returning to displaying keyboards 200 (FIG. 2A) or 202 (FIG. 2B).

As illustrated in FIGS. 9A-9J, each of the subsequent displayed keyboards 900, 902, 904, 906, 908, 910, 912, 914, 916, or 918 (also shown as 900′, 902′, 904′, 906′, 908′, 910′, 912′, 914′, 916′, or 918′ without reference numerals for clarity) may present a series of virtual buttons 51, 52, 53, 54, 55, 56, 57, 58, and/or 59 such that a portion of virtual buttons 23, 24, 25 or 26, 27, 28 originally displayed to the user remain visible. Displayed keyboards 900, 902, 904, 906, 908, 910, 912, 914, 916, or 918 may each be associated with their respective display items tables, 950-960, that reference various image files stored in memory 104, 106 that the processor 102 may retrieve and render to display the keyboards 900, 902, 904, 906, 908, 910, 912, 914, 916, or 918. Displayed keyboards 900, 902, 904, 906, 908, 910, 912, 914, 916, or 918 may also be associated with their own respective interaction tables, 901, 903, 905, 907, 909, 911, 913, 915, 917, or 919 that indicate to the processor 102 different actions to take based on the state of the text entry area 21. The various actions may result in a selected special character being displayed in the text entry area 21, and based on the state of the text entry area 21, the processor 102 may display the keyboards 202 (FIG. 2B) or 206 (FIG. 2D) or return to displaying keyboards 500 (FIG. 5A), 502 (FIG. 5B), 504 (FIG. 5C), 506 (FIG. 5D), 508 (FIG. 5E), or 510 (FIG. 5F) according to the instructions in the tables 901, 903, 905, 907, 909, 911, 913, 915, 917, or 919.

Referring to FIG. 2B, a keyboard 202 with characters in the text entry area 21 and its associated interaction table 203 is displayed. Besides the text entry area 21, the keyboard 202 (shown at 202′ without reference numerals for clarity) includes virtual buttons 23, 24, 25, 26, 27, 28, and an accept icon 22 configured as specified in a display items table 208 associated with the keyboard 202.

In response to the user pressing the “90QRST” virtual button 27 (action 7 in interaction table 203) of keyboard 202 illustrated in FIG. 2B, the processor 201 will display keyboard 508 illustrated in FIG. 5E, which presents a virtual button for each of “9” 51, “0” 52, “T” 53, “Q” 57, “R” 58, and “S” 59. (Keyboard 508′ illustrated in FIG. 5E shows the same keyboard 508 without the element numbers for clarity.) These different virtual buttons 51, 52, 53, 57, 58, and 59 may be rendered according to the display items table 517 associated with the keyboard 508 which may reference various image files stored in memory 104, 106 that the processor 102 may retrieve and render to display the keyboard 508. As illustrated in FIG. 5E, the virtual buttons 51, 52, 53, 57, 58, and 59 are displayed expanded out to portions of the small touchscreen away from the user's previous input action (e.g., the tap on the “90QRST” virtual button 27) such that the row of virtual buttons 26, 27, and 28 remain visible. These individual buttons 51, 52, 53, 57, 58, and 59 can then be pressed (e.g., user finger press and lift on a button, user press and hold of a button, etc.) to enter these letters and numerals according to the instructions in the interaction table 509. The indicated events in the interaction table 509 may include different actions to take based on the state of the text entry area 21. For example, the user pressing the virtual buttons may prompt the processor 102 to present the keyboards 200, 202, 206, or 912, of FIGS. 2A, 2B, 2D, and 9G, respectively, according to the interaction table 509.

In a manner similar to that of FIG. 2A, as shown in interaction table 203 of FIG. 2B, different user interactions with virtual buttons 23, 24, 25, 26, 27, and 28 may also the cause that the processor 102 to render different keyboards 500 (FIG. 5A), 502 (FIG. 5B), 504 (FIG. 5C), 506 (FIG. 5D), 508 (FIG. 5E), or 510 (FIG. 5F).

The displays resulting from interactions with the virtual buttons may depend on both the particular display presented and information contained within the text window. For example, FIG. 2B illustrates a second keyboard 202 with a character “D” entered in the text entry area and its associated interaction table 203. The keyboards 200 (FIG. 2A) and 202 (FIG. 2B) may be selected for display based on the character entry context determined for a character entry event. For example, keyboards 200 (FIG. 2A) and 202 (FIG. 2B) may be selected for display when a letter based context (e.g., a name entry) is determined and upper case characters are needed (e.g., first character in sentence). The keyboards 200 (FIG. 2A) and 202 (FIG. 2B) may display the same six virtual buttons, selectable by a user.

Additionally, FIGS. 2A and 2B also illustrate different actions corresponding to some virtual button interactions as a result of the text window being empty or not being empty. Specifically, while the table of interactions 201 (FIG. 2A) indicates that tapping and holding the text display 21 prompts the processor 102 to generate a cursor control keyboard 1200 illustrated in FIG. 12A with the text entry area 21 empty, the table of interactions 203 (FIG. 2B) indicates that tapping and holding the text display 21 prompts the processor 102 to generate the a cursor control keyboard 1202 illustrated in FIG. 12B, which includes options for editing text that has already been entered in the text entry area 21. Also, entering text into the text window 21 of FIG. 2B changes the accept icon 22 to a check mark, and tapping that accept icon 22 (action 2 in the table of interactions 203) prompts the processor 102 to proceed to the next state with the typed string omitting any empty characters at the end of the string.

Further, according to the interaction table 201 (FIG. 2A) or 203 (FIG. 2B), in response to the user swiping right to left (corresponding to action 9 in table of action 201 or 203), the processor 102 will present the keyboard 204 or 206 illustrated in FIGS. 2C or 2D, respectively.

In a manner similar to those of FIGS. 2A and 2B, FIGS. 2C and 2D illustrate keyboards 204 and 206, respectively, that present lower case letters and other characters selectable by a user (Keyboards 204′ an 206′ illustrated in FIGS. 2C and 2D show the same keyboards 204 and 206 without the element numbers for clarity.) Display item tables 210 (FIG. 2C) and 212 (FIG. 2D) may reference various image files stored in memory 104, 106 that the processor 102 may retrieve and render to display the keyboards 204 and 206, respectively.

FIG. 2C also illustrates that the keyboard 204 may include some hint text to guide or prompt a user, which may be turned on (display 214) or off (display 204′) by a user. For example, hint text may be a string of characters specified by the program state that necessitated a character entry event. In an embodiment, hint text may only be displayed when the text entry area is empty. As described above with reference to FIG. 1B, user interactions with displayed virtual buttons 23-28 in FIGS. 2C or 2D (e.g., a user putting a finger down to tap, tap & hold, swipe right to left, etc.) prompt the processor 102 to present a different display including a keyboard suitable for the user to make an entry in a small touchscreen interface (e.g., the touchscreen display 120 of a smart watch 100). The interaction tables 205 or 207 associated with the keyboards 204 and 206, respectively, may function as look up tables for the processor 102 to determine the appropriate next keyboard to display.

As illustrated in FIGS. 2C and 2D, according to the interaction tables 205 and 207, different user interactions with virtual buttons 23, 24, 25, 26, 27, and 28 may the cause that the processor 102 to render different keyboards 600 (FIG. 6A), 602 (FIG. 6B), 604 (FIG. 6C), 606 (FIG. 6D), 608 (FIG. 6E), or 610 (FIG. 6F). As illustrated in FIGS. 6A-5F, each of the subsequent displayed keyboards 600, 602, 604, 606, 608, or 610 (also shown as 600′, 604′, 606′, 608′, or 610′ without reference numerals for clarity) may present a series of virtual buttons 51, 52, 53, 54, 55, 56, 57, 58, and/or 59 expanded out to portions of the small touchscreen away from the user's previous input action such that the row of virtual buttons 23, 24, 25 or 26, 27, 28 associated with the virtual button selected by the user remains visible. In a further embodiment, the displayed area around virtual buttons 51, 52, 53, 54, 55, 56, 57, 58, and/or 59 may be shown in a different color than virtual buttons 51, 52, 53, 54, 55, 56, 57, 58, and/or 59, such as gray or any other color, to indicate that the different colored area of the display may be associated with an action different from the virtual buttons 51, 52, 53, 54, 55, 56, 57, 58, and/or 59.

Displayed keyboards 600, 602, 604, 606, 608, or 610 may each be associated with their respective display items tables, 612-617, that reference various image files stored in memory 104, 106 that the processor 102 may retrieve and render to display the keyboards 600, 602, 604, 606, 608, or 610. Displayed keyboards 600, 602, 604, 606, 608, or 610 may also be associated with their own respective interaction tables, 601, 603, 605, 607, 609, and 611 that indicate to the processor 102 different actions to take based on the state of the text entry area 21. These actions may include entering text in the text entry area 21 and rendering keyboard 202 (FIG. 2B), 204 (FIG. 2C), or 206 (FIG. 2D) or rendering special character keyboards 920 (FIG. 9K), 922 (FIG. 9L), 924 (FIG. 9M), 926 (FIG. 9N), 928 (FIG. 9O), 930 (FIG. 9P), 932 (FIG. 9Q), 934 (FIG. 9R), 936 (FIG. 9S), 938 (FIG. 9T), 940 (FIG. 9U), 944 (FIG. 9V), 946 (FIG. 9W), or 975 (FIG. 9X).

As illustrated in FIGS. 9K-9X, each of the subsequent displayed keyboards 920, 922, 924, 926, 928, 930, 932, 934, 936, 938, 940, 942, 944, 946, or 975 (also shown as 920′, 922′, 924′, 926′, 928′, 930′, 932′, 934′, 936′, 938′, 940′, 942′, 944′, 946′, or 975′ without reference numerals for clarity) may present a series of virtual buttons 51, 52, 53, 54, 55, 56, 57, 58, and/or 59 such that a portion of virtual buttons 23, 24, 25 or 26, 27, 28 originally displayed to the user remain visible. Displayed keyboards 920, 922, 924, 926, 928, 930, 932, 934, 936, 938, 940, 942, 944, 946, or 975 may each be associated with their respective display items tables 961-973 and 977, which reference various image files stored in memory 104, 106 that the processor 102 may retrieve and render to display the keyboards 920, 922, 924, 926, 928, 930, 932, 934, 936, 938, 940, 942, 944, 946, or 975. Displayed keyboards 920, 922, 924, 926, 928, 930, 932, 934, 936, 938, 940, 942, 944, 946, or 975 may also be associated with their own respective interaction tables, 921, 923, 925, 927, 929, 931, 933, 935, 937, 939, 941, 945, 947, or 976 that indicate to the processor 102 different actions to take based on the state of the text entry area 21.

Additionally, FIGS. 2C and 2D illustrate different actions corresponding to some virtual button interactions as a result of the text window being empty or not being empty. Specifically, while the table of interactions 205 (FIG. 2C) indicates that tapping and holding the text display 21 prompts the processor 102 to generate a cursor control keyboard 1200 illustrated in FIG. 12A with the text entry area 21 empty, the table of interactions 207 (FIG. 2D) indicates that tapping and holding the text display 21 prompts the processor 102 to generate the cursor control keyboard 1202 illustrated in FIG. 12B, which includes options for editing text that has already been entered in the text entry area 21. Also, entering text into the text window 21 of FIG. 2D changes the accept icon 22 to a check mark, and tapping that accept icon 22 (action 2 in the table of interactions 207) prompts the processor 102 to proceed to the next state with the typed string.

Further, according to the interaction table 205 (FIG. 2C) or 207 (FIG. 2D), in response to the user swiping left to right (corresponding to action 10 in table of action 205 or 207), the processor 102 will present the keyboard 200 or 202 illustrated in FIGS. 2A or 2B, respectively. According to the interaction table 205 (FIG. 2C) or 207 (FIG. 2D), in response to the user swiping right to left (corresponding to action 9 in table of action 205 or 207), the processor 102 will present the keyboard 300 or 302 illustrated in FIGS. 3A or 3B, respectively.

In a manner similar to those of FIGS. 2A and 2B, FIGS. 3A and 3B illustrate keyboards 300 and 302, respectively, that present special characters selectable by a user. (Keyboards 305 and 302′ illustrated in FIGS. 3A and 3B show the same keyboards 300 and 302 without the element numbers for clarity.) Display item tables 304 (FIG. 3A) and 307 (FIG. 3B) may reference various image files stored in memory 104, 106 that the processor 102 may retrieve and render to display the keyboards 300 and 302, respectively.

FIG. 3A also illustrates that the keyboard 300 may include some hint text to guide or prompt a user, which may be turned on (display 306) or off (display 305) by a user. For example, hint text may be a string of characters specified by the program state that necessitated a character entry event. In an embodiment, hint text may only be displayed when the text entry area is empty. As described above with reference to FIG. 1B, user interactions with displayed virtual buttons 23-28 in FIGS. 3A or 3B (e.g., a user putting a finger down to tap, tap & hold, swipe right to left, etc.) prompt the processor 102 to present a different display including a keyboard suitable for the user to make an entry in a small touchscreen interface (e.g., the touchscreen display 120 of a smart watch 100). The interaction tables 301 or 303 associated with the keyboards 300 and 302, respectively, may function as look up tables for the processor 102 to determine the appropriate next keyboard to display.

As illustrated in FIGS. 3A and 3B, according to the interaction tables 301 and 303, different user interactions with virtual buttons 23, 24, 25, 26, 27, and 28 may the cause that the processor 102 to render different keyboards 700 (FIG. 7A), 702 (FIG. 7B), 704 (FIG. 7C), 706 (FIG. 7D), 708 (FIG. 7E), or 710 (FIG. 7F). As illustrated in FIGS. 7A-7F, each of the subsequent displayed keyboards 700, 702, 704, 706, 708, or 710 (also shown as 700′, 704′, 706′, 708′, or 710′ without reference numerals for clarity) may present a series of virtual buttons 51, 52, 53, 57, 58, and/or 59 expanded out to portions of the small touchscreen away from the user's previous input action such that the row of virtual buttons 23, 24, 25 or 26, 27, 28 associated with the virtual button selected by the user remains visible. In a further embodiment, the displayed area around virtual buttons 51, 52, 53, 57, 58, and/or 59 may be shown in a different color than virtual buttons 51, 52, 53, 57, 58, and/or 59, such as gray or any other color, to indicate that the different colored area of the display may be associated with an action different from the virtual buttons 51, 52, 53, 57, 58, and/or 59.

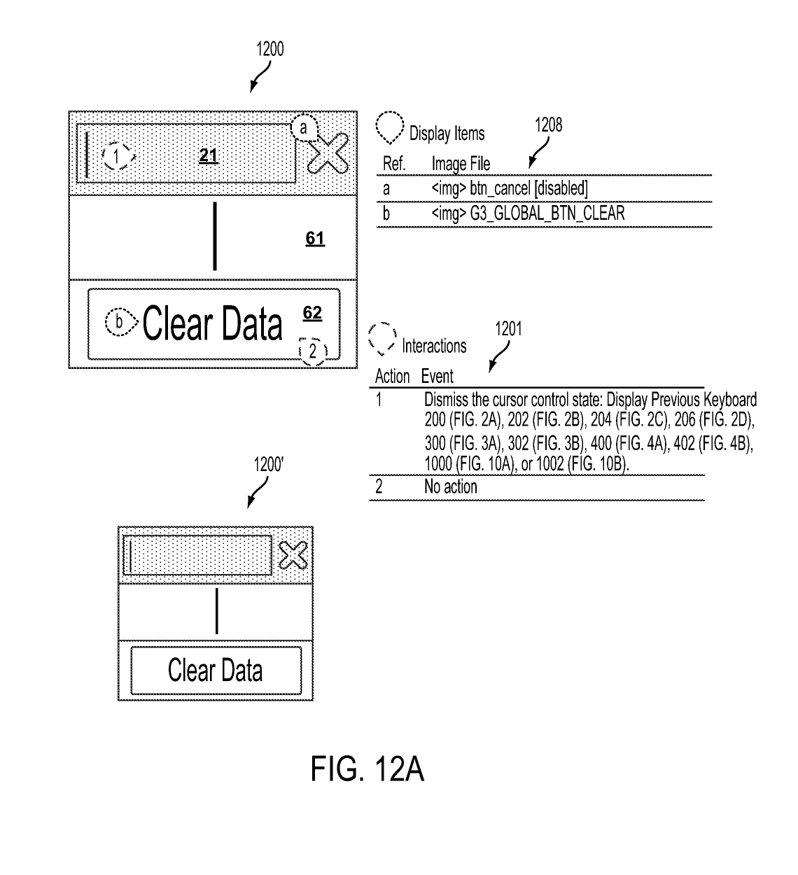

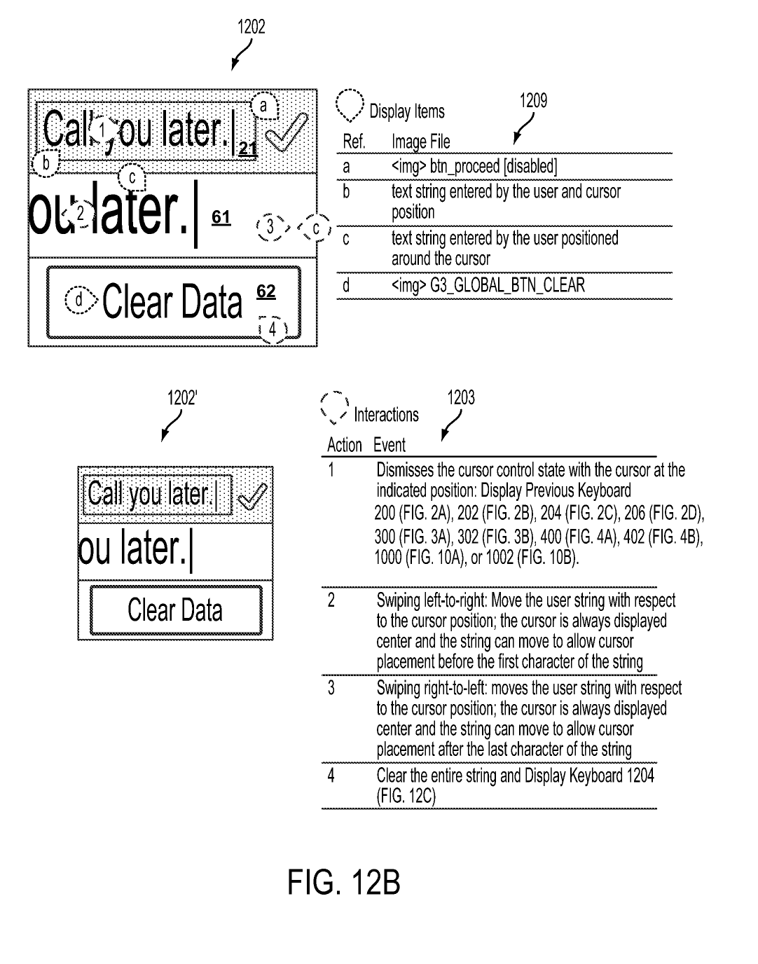

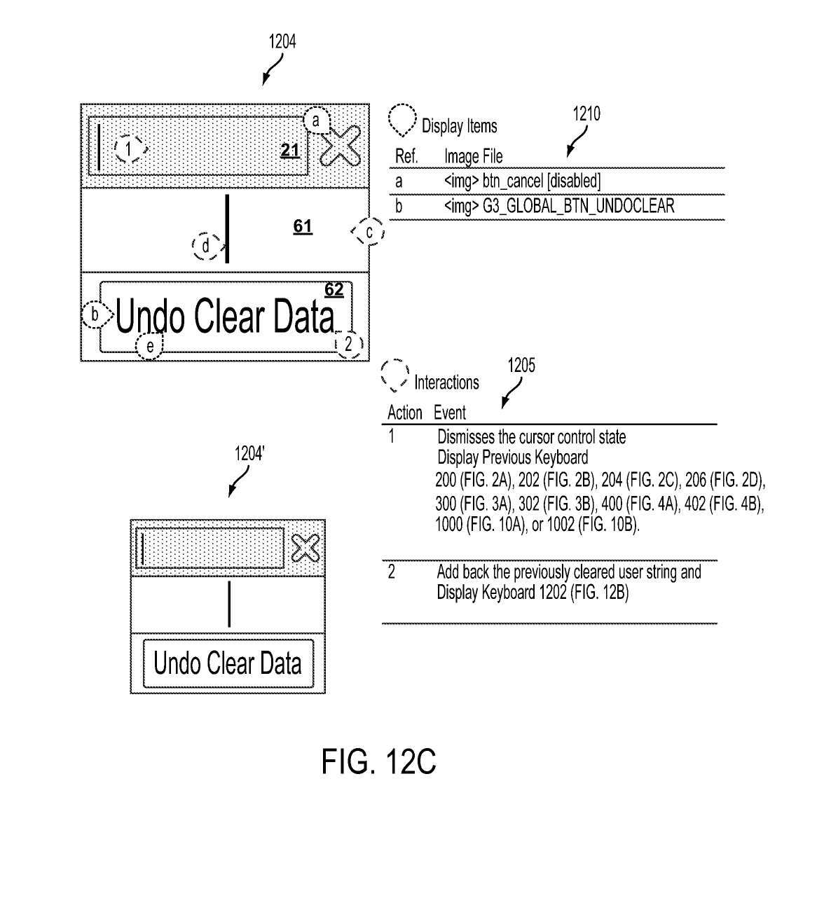

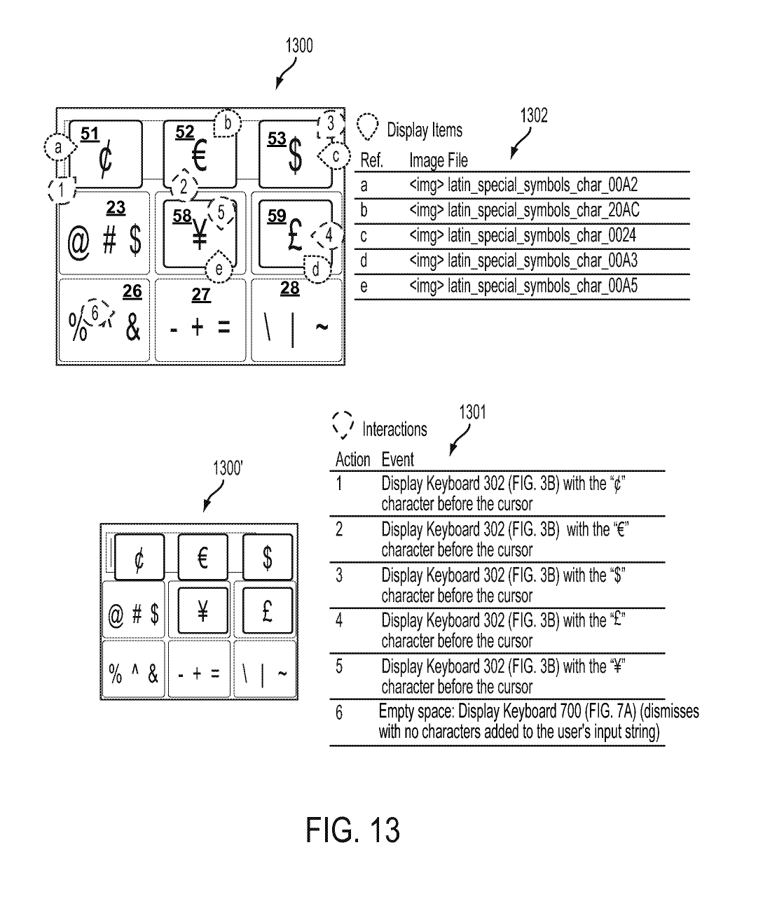

Displayed keyboards 700, 702, 704, 706, 708, or 710 may each be associated with their respective display items tables 712-717, which reference various image files stored in memory 104, 106 that the processor 102 may retrieve and render to display the keyboards 700, 702, 704, 706, 708, or 710. Displayed keyboards 700, 702, 704, 706, 708, or 710 may also be associated with their own respective interaction tables, 701, 703, 705, 707, 709, and 711 that indicate to the processor 102 different actions to take based on the state of the text entry area 21. These actions may include entering text in the text entry area 21 and rendering keyboard 300 (FIG. 3A) or 302 (FIG. 3B) or rendering special character keyboard 1300 (FIG. 13).

As illustrated in FIG. 13, the subsequent displayed keyboard 1300 (also shown as 1300′ without reference numerals for clarity) may present a series of virtual buttons 51, 52, 53, 58, and 59 such that a portion of virtual buttons 23, 24, 25 or 26, 27, 28 originally displayed to the user remain visible. Displayed keyboard 1300 may each be associated with display items table 1302 that references various image files stored in memory 104, 106 that the processor 102 may retrieve and render to display the keyboard 1300. Displayed keyboard 1300 may also be associated with its own interaction table 1301 that indicates to the processor 102 different actions to take based on the state of the text entry area 21.

Additionally, FIGS. 3A and 3B illustrate different actions corresponding to some virtual button interactions as a result of the text window being empty or not being empty. Specifically, while the table of interactions 301 (FIG. 3A) indicates that tapping and holding the text display 21 prompts the processor 102 to generate a cursor control keyboard 1200 illustrated in FIG. 12A with the text entry area 21 empty, the table of interactions 303 (FIG. 3B) indicates that tapping and holding the text display 21 prompts the processor 102 to generate the a cursor control keyboard 1202 illustrated in FIG. 12B, which includes options for editing text that has already been entered in the text entry area 21. Also, entering text into the text window 21 of FIG. 3B changes the accept icon 22 to a check mark, and tapping that accept icon 22 (action 2 in the table of interactions 303) prompts the processor 102 to proceed to the next state with the typed string.

Further, according to the interaction table 301 (FIG. 3A) or 303 (FIG. 3B), in response to the user swiping left to right (corresponding to action 10 in table of action 301 or 303), the processor 102 will present the keyboard 204 or 206 illustrated in FIGS. 2C or 2D, respectively. According to the interaction table 301 (FIG. 3A) or 303 (FIG. 3B), in response to the user swiping right to left (corresponding to action 9 in table of action 301 or 303), the processor 102 will present the keyboard 400 or 402 illustrated in FIGS. 4A or 4B, respectively.

In a manner similar to those of FIGS. 2A and 2B, FIGS. 4A and 4B illustrate keyboards 400 and 402, respectively, that present special characters (e.g., emojis) selectable by a user (Keyboards 405 an 402′ illustrated in FIGS. 4A and 4B show the same keyboards 400 and 402 without the element numbers for clarity.) Display item tables 404 (FIG. 4A) and 408 (FIG. 4B) may reference various image files stored in memory 104, 106 that the processor 102 may retrieve and render to display the keyboards 400 and 402, respectively.

FIG. 4A also illustrates that the keyboard 400 may include some hint text to guide or prompt a user, which may be turned on (display 406) or off (display 405) by a user. For example, hint text may be a string of characters specified by the program state that necessitated a character entry event. In an embodiment, hint text may only be displayed when the text entry area is empty. As described above with reference to FIG. 1B, user interactions with displayed virtual buttons 23-28 in FIGS. 4A or 4B (e.g., a user putting a finger down to tap, tap & hold, swipe right to left, etc.) prompt the processor 102 to present a different display including a keyboard suitable for the user to make an entry in a small touchscreen interface (e.g., the touchscreen display 120 of a smart watch 100). The interaction tables 401 or 403 associated with the keyboards 400 and 402, respectively, may function as look up tables for the processor 102 to determine the appropriate next keyboard to display.

As illustrated in FIGS. 4A and 4B, according to the interaction tables 401 and 403, different user interactions with virtual buttons 23, 24, 25, 26, 27, and 28 may the cause that the processor 102 to render different keyboards 800 (FIG. 8A), 802 (FIG. 8B), 804 (FIG. 8C), 806 (FIG. 8D), 808 (FIG. 8E), or 810 (FIG. 8F). As illustrated in FIGS. 8A-8F, each of the subsequent displayed keyboards 800, 802, 804, 806, 808, or 810 (also shown as 800′, 804′, 806′, 808′, or 810′ without reference numerals for clarity) may present a series of virtual buttons 51, 52, 53, 57, 58, and/or 59 expanded out to portions of the small touchscreen away from the user's previous input action such that the row of virtual buttons 23, 24, 25 or 26, 27, 28 associated with the virtual button selected by the user remains visible. In a further embodiment, the displayed area around virtual buttons 51, 52, 53, 57, 58, and/or 59 may be shown in a different color than virtual buttons 51, 52, 53, 57, 58, and/or 59, such as gray or any other color, to indicate that the different colored area of the display may be associated with an action different from the virtual buttons 51, 52, 53, 57, 58, and/or 59.

Displayed keyboards 800, 802, 804, 806, 808, or 810 may each be associated with their respective display items tables, 812-817, that reference various image files stored in memory 104, 106 that the processor 102 may retrieve and render to display the keyboards 800, 802, 804, 806, 808, or 810. Displayed keyboards 800, 802, 804, 806, 808, or 810 may also be associated with their own respective interaction tables, 801, 803, 805, 807, 809, and 811 that indicate to the processor 102 different actions to take based on the state of the text entry area 21. These actions may include entering text in the text entry area 21 and rendering keyboard 400 (FIG. 3A) or 402 (FIG. 3B).

Additionally, FIGS. 4A and 4B also illustrate different actions corresponding to some virtual button interactions as a result of the text window being empty or not being empty. Specifically, while the table of interactions 401 (FIG. 4A) indicates that tapping and holding the text display 21 prompts the processor 102 to generate a cursor control keyboard 1200 illustrated in FIG. 12A with the text entry area 21 empty, the table of interactions 403 (FIG. 4B) indicates that tapping and holding the text display 21 prompts the processor 102 to generate the a cursor control keyboard 1202 illustrated in FIG. 12B, which includes options for editing text that has already been entered in the text entry area 21. Also, entering text into the text window 21 of FIG. 4B changes the accept icon 22 to a check mark, and tapping that accept icon 22 (action 2 in the table of interactions 403) prompts the processor 102 to proceed to the next state with the typed string.

Further, according to the interaction table 401 (FIG. 4A) or 403 (FIG. 3B), in response to the user swiping left to right (corresponding to action 9 in table of action 401 or 403), the processor 102 will present the keyboard 300 or 302 illustrated in FIGS. 3A or 3B, respectively.

In a manner similar to those of FIGS. 2A and 2B, FIGS. 10A and 10B illustrate keyboards 1000 and 1002, respectively, that present numbers selectable by a user (Keyboards 1005 an 1002′ illustrated in FIGS. 10A and 10B show the same keyboards 1000 and 1002 without the element numbers for clarity.) In various embodiments, according to the operations of method 130 of FIG. 1B, in response to the processor 102 of the smart watch 100 determining that the current character context is to numbers only, the processor may select and display keyboard 1000 (FIG. 10A), which only displays and supports selection of numbers by a user, rather than selecting and displaying keyboard 200 (FIG. 2A). Display item tables 1004 (FIG. 10A) and 1007 (FIG. 10B) may reference various image files stored in memory 104, 106 that the processor 102 may retrieve and render to display the keyboards 1000 and 1002, respectively.

FIG. 10A also illustrates that the keyboard 1000 may include some hint text to guide or prompt a user, which may be turned on (display 1006) or off (display 1005) by a user. For example, hint text may be a string of characters specified by the program state that necessitated a character entry event. In an embodiment, hint text may only be displayed when the text entry area is empty. As described above with reference to FIG. 1B, user interactions with displayed virtual buttons 23-28 in FIGS. 10A or 10B (e.g., a user putting a finger down to tap, tap & hold, swipe right to left, etc.) prompt the processor 102 to present a different display including a keyboard suitable for the user to make an entry in a small touchscreen interface (e.g., the touchscreen display 120 of a smart watch 100). The interaction tables 1001 or 1003 associated with the keyboards 1000 and 1002, respectively, may function as look up tables for the processor 102 to determine the appropriate next keyboard to display.

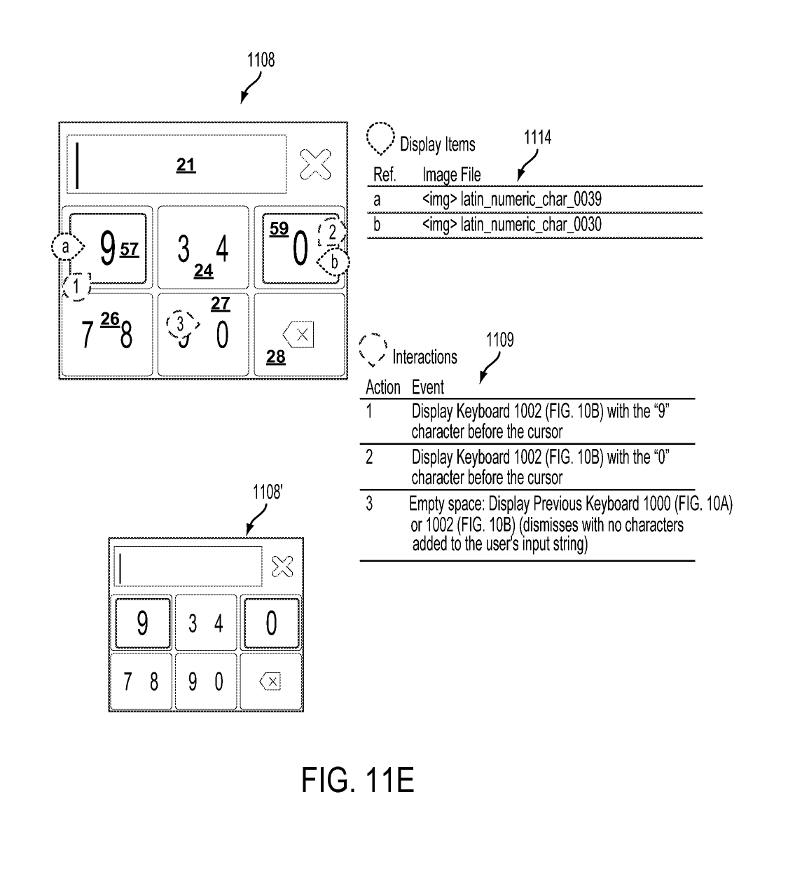

As illustrated in FIGS. 10A and 10B, according to the interaction tables 1001 and 1003, different user interactions with virtual buttons 23, 24, 25, 26, 27, and 28 may the cause that the processor 102 to render different keyboards 1100 (FIG. 11A), 1102 (FIG. 11B), 1104 (FIG. 11C), 1106 (FIG. 11D), or 1108 (FIG. 11E). As illustrated in FIGS. 11A-11E, each of the subsequent displayed keyboards 1100, 1102, 1104, 1106, or 1108 (also shown as 1100′, 1102′, 1104′, 1106′, or 1108′ without reference numerals for clarity) may present a series of virtual buttons 51, 52, 53, 57, 58, and/or 59 expanded out to portions of the small touchscreen away from the user's previous input action such that the row of virtual buttons 23, 24, 25 or 26, 27, 28 associated with the virtual button selected by the user remains visible. In a further embodiment, the displayed area around virtual buttons 51, 52, 53, 57, 58, and/or 59 may be shown in a different color than virtual buttons 51, 52, 53, 57, 58, and/or 59, such as gray or any other color, to indicate that the different colored area of the display may be associated with an action different from the virtual buttons 51, 52, 53, 57, 58, and/or 59.

Displayed keyboards 1100, 1102, 1104, 1106, or 1108 may each be associated with their respective display items tables, 1110-1114, that reference various image files stored in memory 104, 106 that the processor 102 may retrieve and render to display the keyboards 1100, 1102, 1104, 1106, or 1108. Displayed keyboards 1100, 1102, 1104, 1106, or 1108 may also be associated with their own respective interaction tables, 1100, 1102, 1104, 1106, or 1108 that indicate to the processor 102 different actions to take based on the state of the text entry area 21. These actions may include entering text in the text entry area 21 and rendering keyboard 1000 (FIG. 10A) or 1002 (FIG. 10B).

Additionally, FIGS. 10A and 10B illustrate different actions corresponding to some virtual button interactions as a result of the text window being empty or not being empty. Specifically, while the table of interactions 1001 (FIG. 10A) indicates that tapping and holding the text display 21 prompts the processor 102 to generate a cursor control keyboard 1200 illustrated in FIG. 12A with the text entry area 21 empty, the table of interactions 1003 (FIG. 10B) indicates that tapping and holding the text display 21 prompts the processor 102 to generate the cursor control keyboard 1202 illustrated in FIG. 12B, which includes options for editing text that has already been entered in the text entry area 21. Also, entering text into the text window 21 of FIG. 10B changes the accept icon 22 to a check mark, and tapping that accept icon 22 (action 2 in the table of interactions 1003) prompts the processor 102 to proceed to the next state with the typed string.

As discussed above, in FIG. 12A a cursor control keyboard 1200 is illustrated with the text entry area 21 empty. (Also shown as 1200′ without reference numerals for clarity.) Display item table 1208 may reference various image files stored in memory 104, 106 that the processor 102 may retrieve and render to display the keyboard 1200. The cursor control keyboard 1200 may include text entry area 21, a second text entry area 61, and virtual button 62. The table of interactions 1201 indicates that tapping in the text entry area 21 dismisses the cursor control state and returns to the previously displayed keyboard which may include one or keyboards 200 (FIG. 2A), 202 (FIG. 2B), 204 (FIG. 2C), 206 (FIG. 2D), 300 (FIG. 3A), 302 (FIG. 3B), 400 (FIG. 4A), 402 (FIG. 4B), 1000 (FIG. 10A), or 1002 (FIG. 10B).

As discussed above, in FIG. 12B a cursor control keyboard 1202 is illustrated with the text entry area 21 including text of a previously entered text string. (Also shown as 1202′ without reference numerals for clarity.) Display item table 1209 may reference various image files stored in memory 104, 106 that the processor 102 may retrieve and render to display the keyboard 1202. The cursor control keyboard 1202 may include a first text entry area 21, a second text entry area 61, and a virtual button 62. The table of interactions 1203 indicates that tapping in the first text entry area 21 dismisses the cursor control state and returns to the previously displayed keyboard which may include one or keyboards 200 (FIG. 2A), 202 (FIG. 2B), 204 (FIG. 2C), 206 (FIG. 2D), 300 (FIG. 3A), 302 (FIG. 3B), 400 (FIG. 4A), 402 (FIG. 4B), 1000 (FIG. 10A), or 1002 (FIG. 10B). Additionally, swiping left to right or right to left in the second text entry area 61 may enable the user to control the position of the cursor in the displayed text string, and taping the virtual button 62 may cause the processor 102 to present the keyboard 1204 illustrated in FIG. 12C.

FIG. 12C is a cursor control keyboard 1204 with the text entry area 21 empty. (Also shown as 1204′ without reference numerals for clarity.) Display item table 1210 may reference various image files stored in memory 104, 106 that the processor 102 may retrieve and render to display the keyboard 1204. The cursor control keyboard 1204 may include a first text entry area 21, a second text entry area 61, and virtual button 62. The table of interactions 1201 indicates that tapping in the first text entry area 21 dismisses the cursor control state and returns to the previously displayed keyboard which may include one or keyboards 200 (FIG. 2A), 202 (FIG. 2B), 204 (FIG. 2C), 206 (FIG. 2D), 300 (FIG. 3A), 302 (FIG. 3B), 400 (FIG. 4A), 402 (FIG. 4B), 1000 (FIG. 10A), or 1002 (FIG. 10B), while tapping the virtual button 62 may cause the processor 102 to insert a previously cleared text string and present the keyboard 1202 illustrated in FIG. 12B.

It should be noted that the displays and interactions illustrated in FIGS. 2A-13 are merely an example of one organization of keyboards that may be implemented according to various embodiments, and that other keyboard organizations, presentations and interrelationships may be implemented without departing from the scope of the claims.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein, particularly the embodiment method 130 described with reference to FIG. 1B, may be implemented or performed with the smart watch 100 and its various components described above with reference to FIG. 1A. For example, the processor 102 of the smart watch 100 may be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processor 102 may be a microprocessor, but, in the alternative, the processor 102 may be any conventional processor, controller, microcontroller, or state machine. The processor 102 may also be implemented as a combination of devices, e.g., a combination of a DSP and a microprocessor, a plurality of microprocessors, one or more microprocessors in conjunction with a DSP core, or any other such configuration. Alternatively, some steps or methods may be performed by circuitry of the smart watch 100 that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein, particularly the embodiment method 130 described with reference to FIG. 1B, may be embodied in a processor-executable software module which may reside on a non-transitory computer-readable or processor-readable storage medium. Non-transitory computer-readable or processor-readable storage media may be any storage media that may be accessed by a processor, such as the processor 102 of smart watch 100 described with reference to FIG. 1A. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by the processor 102, an may include memories 104, 106. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for displaying a keyboard on a touchscreen display of a device, comprising:
displaying a first keyboard comprising a text entry area and one or more virtual buttons;
determining a user input action indication;
determining a text entry area state; and
displaying a second keyboard with different virtual buttons than the first keyboard based on the first keyboard, the user input action indication, and the text entry area state,
wherein the virtual buttons of the second keyboard are displayed expanded out to portions of the touchscreen display away from a portion of the touchscreen display selected in the user input action indication and the second keyboard is displayed such that a portion of the first keyboard remains visible to a user.

2. The method of claim 1, further comprising displaying the second keyboard with different virtual buttons than the first keyboard based on a correlation of the user input action indication and the text entry area state with an event action in an interaction table associated with the first keyboard.

3. The method of claim 2, wherein:
the virtual buttons of the first keyboard are rendered according to a first display items table associated with the first keyboard;
the virtual buttons of the second keyboard are rendered according to a second display items table associated with the first keyboard; and
the first display items table and the second display items table reference different image files.

4. The method of claim 3, further comprising:
determining a second user input action indication in response to displaying the second keyboard; and
displaying a character string in the text entry area based on the second keyboard and the second user input action indication.

5. The method of claim 4, wherein the second user input action indication is a swipe.

6. The method of claim 1, wherein the portion of the first keyboard that remains visible to the user is a row of the one or more virtual buttons.

7. A device, comprising:
a touchscreen display; and
a processor connected to the touchscreen display, wherein the processor is configured with processor executable instructions to perform operations to:
display a first keyboard comprising a text entry area and one or more virtual buttons on the touchscreen display;
determine a user input action indication;
determine a text entry area state; and
display, on the touchscreen display, a second keyboard with different virtual buttons than the first keyboard based on the first keyboard, the user input action indication, and the text entry area state, wherein the virtual buttons of the second keyboard are displayed expand out to portions of the touchscreen display away from a portion of the touchscreen display selected in the user input action indication and the second keyboard is displayed such that a portion of the first keyboard remains visible to a user.

8. The device of claim 7, wherein the processor is configured with processor executable instructions to perform operations to display, on the touchscreen display, the second keyboard with different virtual buttons than the first keyboard based on a correlation of the user input action indication and the text entry area state with an event action in an interaction table associated with the first keyboard.

9. The device of claim 8, wherein:
the virtual buttons of the first keyboard are rendered according to a first display items table associated with the first keyboard;
the virtual buttons of the second keyboard are rendered according to a second display items table associated with the first keyboard; and
the first display items table and the second display items table reference different image files.

10. The device of claim 9, wherein the processor is configured with processor executable instructions to further perform operations to:
determine a second user input action indication in response to displaying the second keyboard; and
display, on the touchscreen display, a character string in the text entry area based on the second keyboard and the second user input action indication.

11. The device of claim 10, wherein the second user input action indication is a swipe.

12. The device of claim 1, wherein the portion of the first keyboard that remains visible to the user is a row of the one or more virtual buttons.

13. A device, comprising:
a touchscreen display;
means for displaying a first keyboard comprising a text entry area and one or more virtual buttons on the touchscreen display;
means for determining a user input action indication;
means for determining a text entry area state; and
means for displaying, on the touchscreen display, a second keyboard with different virtual buttons than the first keyboard based on the first keyboard, the user input action indication, and the text entry area state, wherein the virtual buttons of the second keyboard are displayed expand out to portions of the touchscreen display away from a portion of the touchscreen display selected in the user input action indication and the second keyboard is displayed such that a portion of the first keyboard remains visible to a user.

14. The device of claim 13, further comprising means for displaying the second keyboard with different virtual buttons than the first keyboard based on a correlation of the user input action indication and the text entry area state with an event action in an interaction table associated with the first keyboard.

15. The device of claim 14, wherein:
the virtual buttons of the first keyboard are rendered according to a first display items table associated with the first keyboard;
the virtual buttons of the second keyboard are rendered according to a second display items table associated with the first keyboard; and
the first display items table and the second display items table reference different image files.

16. The device of claim 15, further comprising:
means for determining a second user input action indication in response to displaying the second keyboard; and
means for displaying on the touchscreen display a character string in the text entry area based on the second keyboard and the second user input action indication.

17. The device of claim 16, wherein the second user input action indication is a swipe.

18. The device of claim 13, wherein the portion of the first keyboard that remains visible to the user is a row of the one or more virtual buttons.

19. A non-transitory processor-readable storage medium having stored thereon processor-executable instructions configured to cause a processor of device to perform operations comprising:
displaying a first keyboard comprising a text entry area and one or more virtual buttons on a touchscreen display;
determining a user input action indication;
determining a text entry area state; and
displaying, on the touchscreen display, a second keyboard with different virtual buttons than the first keyboard based on the first keyboard, the user input action indication, and the text entry area state, wherein the virtual buttons of the second keyboard are displayed expand out to portions of the touchscreen display away from a portion of the touchscreen display selected in the user input action indication and the second keyboard is displayed such that a portion of the first keyboard remains visible to a user.

20. The non-transitory processor-readable storage medium of claim 19, wherein the stored processor-executable instructions are configured to cause a processor of a device to perform operations further comprising displaying, on the touchscreen display, the second keyboard with different virtual buttons than the first keyboard based on a correlation of the user input action indication and the text entry area state with an event action in an interaction table associated with the first keyboard.

21. The non-transitory processor-readable storage medium of claim 20, wherein the stored processor-executable instructions are configured to cause a processor of a device to perform operations such that:
the virtual buttons of the first keyboard are rendered according to a first display items table associated with the first keyboard;
the virtual buttons of the second keyboard are rendered according to a second display items table associated with the first keyboard; and
the first display items table and the second display items table reference different image files.

22. The non-transitory processor-readable storage medium of claim 21, wherein the stored processor-executable instructions are configured to cause a processor of a device to perform operations further comprising:
determining a second user input action indication in response to displaying the second keyboard; and
displaying, on the touchscreen display, a character string in the text entry area based on the second keyboard and the second user input action indication.

23. The non-transitory processor-readable storage medium of claim 22, wherein the stored processor-executable instructions are configured to cause a processor of a device to perform operations such that the second user input action indication is a swipe.

24. The non-transitory processor-readable storage medium of claim 19, wherein the stored processor-executable instructions are configured to cause a processor of a device to perform operations such that the portion of the first keyboard that remains visible to the user is a row of the one or more virtual buttons.
